(19) United States
(12) Patent Application Publication
(10) Pub. No.: US 2026/0046411 A1
(43) Pub. Date: Feb. 12, 2026

(54) VARIABLE INTRA-FRAME (I-FRAME) TIME INTERVAL AND GROUP OF PICTURE (GOP) LENGTH FOR VIDEO CODING

(71) Applicant: QUALCOMM Incorporated, San Diego, CA (US)

(72) Inventor: Nan ZHANG, Beijing (CN)

(21) Appl. No.: 19/100,225

(22) PCT Filed: Sep. 20, 2022
(86) PCT No.: PCT/CN2022/119802

§ 371 Date: Jan. 31, 2025

(51) Int. Cl. H04N 19/136; H04N 19/142; H04N 19/172; H04N 19/177; H04N 19/503

(52) U.S. Cl. CPC H04N 19/136; H04N 19/142; H04N 19/172; H04N 19/177; H04N 19/503

(57) ABSTRACT

Systems and techniques are provided for processing video data. For example, a process can include obtaining a frame of video data associated with a display of a computing device, wherein the frame of video data includes one or more layers. Layer information associated with the one or more layers included in the frame of video data can be compared with layer information associated with one or more layers included in a previous frame of video data. Based on determining a frame geometry change associated with the frame of video data, an inter-predicted frame can be generated using the frame of video data. An updated group of pictures (GOP) length can be determined based on the layer information associated with the one or more layers included in the frame of video data.

### CROSS-REFERENCE TO RELATED APPLICATIONS

This application for patent is a 371 of international Patent Application PCT/CN2022/119802, filed Sep. 20, 2022, which is hereby incorporated by referenced in its entirety and for all purposes.

### FIELD

The present disclosure generally relates to video coding (e.g., including encoding and/or decoding of video data). For example, aspects of the present disclosure relate to improving video coding techniques related to variable intra-frame time intervals and/or group of picture (GOP) lengths.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Such devices allow video data to be processed and output for consumption. Digital video data includes large amounts of data to meet the demands of consumers and video providers. For example, consumers of video data desire video of the utmost quality, with high fidelity, resolutions, frame rates, and the like. As a result, the large amount of video data that is required to meet these demands places a burden on communication networks and devices that process and store the video data.

Digital video devices can implement video coding techniques to compress video data. Video coding is performed according to one or more video coding standards or formats. For example, video coding standards or formats include versatile video coding (VVC), high-efficiency video coding (HEVC), advanced video coding (AVC), MPEG-2 Part 2 coding (MPEG stands for moving picture experts group), among others, as well as proprietary video codecs/formats such as AOMedia Video 1 (AV1) that was developed by the Alliance for Open Media. Video coding generally utilizes prediction methods (e.g., inter prediction, intra prediction, or the like) that take advantage of redundancy present in video images or sequences. A goal of video coding techniques is to compress video data into a form that uses a lower bit rate, while avoiding or minimizing degradations to video quality. With ever-evolving video services becoming available, coding techniques with better coding efficiency are needed.

### BRIEF SUMMARY

In some examples, systems and techniques are described for performing video coding using a variable intra-frame (I-frame) time interval and/or a variable length group of pictures (GOP) length. For example, the systems and techniques can perform video coding (e.g., encoding and/or decoding) using a variable I-frame interval and/or a variable GOP length that is determined based on information such as video frame layer information, video frame layer geometry. According to at least one illustrative example, a method is provided for processing video data. The method includes: obtaining a frame of video data associated with a display of a computing device, wherein the frame of video data includes one or more layers; comparing layer information associated with the one or more layers included in the frame of video data and layer information associated with one or more layers included in a previous frame of video data; generating, based on determining a frame geometry change associated with the frame of video data, an inter-predicted frame using the frame of video data; and determining an updated group of pictures (GOP) length based on the layer information associated with the one or more layers included in the frame of video data.

In another example, an apparatus is provided that includes at least one memory (e.g., configured to store data) and at least one processor (e.g., implemented in circuitry) coupled to the at least one memory. The at least one processor is configured to and can: obtain a frame of video data associated with a display of a computing device, wherein the frame of video data includes one or more layers; compare layer information associated with the one or more layers included in the frame of video data and layer information associated with one or more layers included in a previous frame of video data; generate, based on determining a frame geometry change associated with the frame of video data, an inter-predicted frame using the frame of video data; and determine an updated group of pictures (GOP) length based on the layer information associated with the one or more layers included in the frame of video data.

In another example, a non-transitory computer-readable medium is provided that has stored thereon instructions that, when executed by one or more processors, cause the one or more processors to: obtain a frame of video data associated with a display of a computing device, wherein the frame of video data includes one or more layers; compare layer information associated with the one or more layers included in the frame of video data and layer information associated with one or more layers included in a previous frame of video data; generate, based on determining a frame geometry change associated with the frame of video data, an inter-predicted frame using the frame of video data; and determine an updated group of pictures (GOP) length based on the layer information associated with the one or more layers included in the frame of video data.

In another example, an apparatus is provided that includes: means for obtaining a frame of video data associated with a display of a computing device, wherein the frame of video data includes one or more layers; means for comparing layer information associated with the one or more layers included in the frame of video data and layer information associated with one or more layers included in a previous frame of video data; means for generating, based on determining a frame geometry change associated with the frame of video data, an inter-predicted frame using the frame of video data; and means for determining an updated group of pictures (GOP) length based on the layer information associated with the one or more layers included in the frame of video data.

In some aspects, one or more of the apparatuses described herein is, is part of, and/or includes a mobile device or wireless communication device (e.g., a mobile telephone or other mobile device), an extended reality (XR) device or system (e.g., a virtual reality (VR) device, an augmented reality (AR) device, or a mixed reality (MR) device), a wearable device (e.g., a network-connected watch or other wearable device), a camera, a personal computer, a laptop computer, a vehicle or a computing device or component of a vehicle, a server computer or server device, another device, or a combination thereof. In some aspects, the apparatus includes a camera or multiple cameras for capturing one or more images. In some aspects, the apparatus further includes a display for displaying one or more images, notifications, and/or other displayable data. In some aspects, the apparatuses described above can include one or more sensors (e.g., one or more inertial measurement units (IMUs), such as one or more gyroscopes, one or more gyrometers, one or more accelerometers, any combination thereof, and/or other sensor.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 is a block diagram illustrating an example of an encoding device and a decoding device, in accordance with some examples of the disclosure;

FIG. 2A is a diagram illustrating an example of angular prediction modes, in accordance with some examples;

FIG. 2B is a diagram illustrating an example of directional intra-prediction modes in Versatile Video Coding (VVC), in accordance with some examples;

FIG. 3 is a diagram illustrating an example of a group of pictures (GOP) length and an inter-frame (I-frame) time interval, in accordance with some examples;

FIG. 4A is a diagram illustrating an example of frame layers associated with a frame of captured video display data, in accordance with some examples;

FIG. 4B is a diagram illustrating an example of a video frame layer stack associated with a frame of captured video display data, in accordance with some examples;

FIG. 4C is a diagram illustrating an example table including layer information associated with a plurality of layers included in a given frame of captured video display data, in accordance with some examples;

FIG. 5 is a flow chart illustrating an example of a process for performing video coding using a variable I-frame time interval and a variable GOP length, in accordance with some examples;

FIG. 6 is a flow chart illustrating another example of a process for performing video coding using a variable I-frame time interval and a variable GOP length, in accordance with some examples;

FIG. 7 is a block diagram illustrating an example video encoding device, in accordance with some examples; and

FIG. 8 is a block diagram illustrating an example video decoding device, in accordance with some examples.

### DETAILED DESCRIPTION

Certain aspects and aspects of this disclosure are provided below. Some of these aspects and aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides exemplary aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

Digital video data can include large amounts of data, particularly as the demand for high quality video data continues to grow. For example, consumers of video data typically desire video of increasingly high quality, with high fidelity, resolution, frame rates, and the like. However, the large amount of video data required to meet such demands can place a significant burden on communication networks as well as on devices that process and store the video data.

Video coding devices (e.g., encoding devices, decoding devices, or combined encoding-decoding devices) implement video compression techniques to code (e.g., encode and/or decode) video data efficiently. Video compression techniques may include applying different prediction modes, including spatial prediction (e.g., intra-frame prediction or intra-prediction), temporal prediction (e.g., inter-frame prediction or inter-prediction), inter-layer prediction (across different layers of video data), and/or other prediction techniques to reduce or remove redundancy inherent in video sequences. A video encoder can partition each picture of an original video sequence into rectangular regions referred to as video blocks or coding units (described in greater detail below). These video blocks may be encoded using a particular prediction mode.

Video blocks may be divided in one or more ways into one or more groups of smaller blocks. Blocks can include coding tree blocks, prediction blocks, transform blocks, or other suitable blocks. References generally to a “block,” unless otherwise specified, may refer to such video blocks (e.g., coding tree blocks, coding blocks, prediction blocks, transform blocks, or other appropriate blocks or sub-blocks, as would be understood by one of ordinary skill). Further, each of these blocks may also interchangeably be referred to herein as “units” (e.g., coding tree unit (CTU), coding unit, prediction unit (PU), transform unit (TU), or the like). In some cases, a unit may indicate a coding logical unit that is encoded in a bitstream, while a block may indicate a portion of video frame buffer a process is target to.

For inter-prediction modes, a video encoder can search for a block similar to the block being encoded in a frame (or picture) located in another temporal location, referred to as a reference frame or a reference picture. The video encoder may restrict the search to a certain spatial displacement from the block to be encoded. A best match may be located using a two-dimensional (2D) motion vector that includes a horizontal displacement component and a vertical displacement component. For intra-prediction modes, a video encoder may form the predicted block using spatial prediction techniques based on data from previously encoded neighboring blocks within the same picture.

The video encoder may determine a prediction error. For example, the prediction can be determined as the difference between the pixel values in the block being encoded and the predicted block. The prediction error can also be referred to as the residual. The video encoder may also apply a transform to the prediction error (e.g., a discrete cosine transform (DCT) or other suitable transform) to generate transform coefficients. After transformation, the video encoder may quantize the transform coefficients. The quantized transform coefficients and motion vectors may be represented using syntax elements, and, along with control information, form a coded representation of a video sequence. In some instances, the video encoder may entropy encode the quantized transform coefficients and/or the syntax elements, thereby further reducing the number of bits needed for their representation.

After entropy decoding and de-quantizing the received bitstream, a video decoder may, using the syntax elements and control information discussed above, construct predictive data (e.g., a predictive block) for decoding a current frame. For example, the video decoder may add the predicted block and the compressed prediction error. The video decoder may determine the compressed prediction error by weighting the transform basis functions using the quantized coefficients. The difference between the reconstructed frame and the original frame is called reconstruction error.

Video coding can be performed according to a particular video coding standard. Examples of video coding standards include, but are not limited to, ITU-T H.261, ISO/IEC MPEG-1 Visual, ITU-T H.262 or ISO/IEC MPEG-2 Visual, ITU-T H.263, ISO/IEC MPEG-4 Visual, Advanced Video Coding (AVC) or ITU-T H.264, including its Scalable Video Coding (SVC) and Multiview Video Coding (MVC) extensions, High Efficiency Video Coding (HEVC) or ITU-T H.265, including its range and screen content coding, 3D video coding (3D-HEVC), multiview (MV-HEVC), and scalable (SHVC) extensions, Versatile Video Coding (VVC) or ITU-T H.266 and its extensions, VP9, Alliance of Open Media (AOMedia) Video 1 (AV1), Essential Video Coding (EVC), among others.

As noted above, a video encoder can partition each picture of an original video sequence into one or more smaller blocks or rectangular regions, which may then be encoded using, for example, intra-prediction (or intra-frame prediction) to remove spatial redundancy inherent to the original video sequence. If a block is encoded in an intra-prediction mode, a prediction block is formed based on previously encoded and reconstructed blocks (e.g., included in the same frame of video data), which are available in both the video encoder and the video decoder to form a prediction reference. For example, the spatial prediction of the pixel values inside of a current block (e.g., currently encoded or currently decoded) can be determined using the pixel values of the adjacent, previously encoded blocks associated with the same frame of video data. These pixel values are used as reference pixels. The reference pixels can be organized into one or more reference pixel lines and/or reference pixel groups. In some examples, intra-prediction can be applied for both luma and chroma components of a block.

A number of different intra-prediction modes can be utilized to provide different spatial prediction techniques to form a predicted reference or predicted block based on the data from previously encoded neighboring blocks within the same picture (e.g., from the reference pixels). Intra-prediction modes can include planar and DC modes and/or directional intra-prediction modes (also referred to as “regular intra-prediction modes”). In some examples, a single planar intra-prediction and a single DC intra-prediction mode can be used, along with multiple directional intra-prediction modes. Intra-prediction modes describe different variants or approaches for calculating pixel values in the area being coded based on reference pixel values. In an illustrative example, the HEVC standard provides 33 directional intra-prediction modes. In another illustrative example, VVC and/or VVC Test Model 5 (VTM5) extend the HEVC directional intra-prediction modes to provide a total of 93 directional intra-prediction modes.

At a video decoder, the choice of intra-prediction mode for each block (e.g., corresponding to the choice of intra-prediction mode made by the video encoder when generating the encoded block) can be determined (e.g., derived) by the decoder or can be signaled to the video decoder, such as in the syntax of the bitstream. For example, in some cases, intra-prediction modes between neighboring blocks may be correlated (e.g., if two adjacent, previously encoded blocks were predicted using intra-prediction mode 2 then it is likely that the best intra-prediction mode for the current block is also intra-prediction mode 2). In some examples, for each current block, the video encoder and the video decoder can calculate the most probable intra-prediction mode. The video encoder may also signal an intra-prediction mode to the video decoder (e.g., using flags, mode parameters, mode selectors, etc.).

In the current VVC standard, 93 directional intra-prediction modes are provided, as previously noted. Each intra-prediction mode is associated with a different angular direction, such that the intra-prediction modes are unique and non-overlapping. Directional intra-prediction modes can be classified as either integer angled modes or fractional (non-integer angled) modes. For a given block of video data, an integer angled intra-prediction mode has a reference pixel at an integer position, e.g., the integer angled intra-prediction mode has a slope that passes through the position of a reference pixel located at the perimeter of the currently coded block. In comparison, a fractional intra-prediction mode does not have a reference pixel at an integer position, an instead has a slope that passes through a point somewhere between two adjacent reference pixels (e.g., a slope of a pixel at a fractional position i+f (i: integer part, f: fractional part) passes through a pixel i and a pixel i+1).

In some aspects, video coding can be performed using a combination of intra-prediction frames (I-frames), predicted frames (P-frames), and/or bi-directional frames (B-frames). For example, an I-frame can include only blocks of video data that use intra-prediction. In some aspects, I-frames can be used as key frames, based on an I-frame including only blocks of video data that are referenced to other blocks of video data within the same I-frame. For example, an I-frame can be utilized as a key frame with respect to one or more P-frames and/or B-frames that are sequentially located before or after the I-frame. In some aspects, the one or more P-frames may be generated to refer to previously encoded I-frames (e.g., acting as key frames) and/or previously encoded P-frames. In some examples, the one or more B-frames may be generated to refer to both previously encoded and subsequently decoded (e.g., future) frames, both of which can include I-frames (e.g., acting as key frames).

In some aspects, the distance between two key frames (e.g., I-frames) can be referred to as a group of pictures (GOP) or GOP length. GOP length can be measured in a number of frames between two I-frame key frames or an amount of time between two I-frame key frames. For example, if one I-frame is inserted and used as a key frame for every one second of video at 30 frames per second, the GOP length is 30 frames, or one second.

In some examples, video coding can be performed using a variable I-frame time interval (e.g., also referred to as a “variable GOP length”). For example, a variable I-frame time interval or GOP length can be used to improve the efficiency of video coding. In some aspects, optimal video coding efficiency for different types of video content may be associated with different GOP lengths. For example, a relatively static video content can be coded using a relatively large GOP length (e.g., based on the video content changing relatively little over time), while a video content with rapid movements or many moving objects may be coded using a relatively small GOP length (e.g., based on the video content changing relatively rapidly over time).

In some aspects, variable length GOP video coding (e.g., encoding and/or decoding) can be based on video content analysis and/or motion analysis to determine an amount of change over time that is associated with the video content. Such techniques can achieve improved video coding performance but are often associated with a high computational complexity and power consumption (e.g., associated with performing a video content analysis and/or motion analysis separate from the video coding). In some cases, fixed length GOP video coding (e.g., fixed I-frame time interval video coding) may be utilized based on computational constraints, power constraints, and/or coding time constraints associated with a given video coding device.

For example, WiFi display techniques (e.g., such as Miracast®) can be used to wirelessly share video content between WiFi devices by capturing and encoding the display contents of a source device (e.g., a smartphone) and transmitting the encoded video data to a receiving device (e.g., a television). Based on the computational resources and/or the power and energy resources available at the source device (e.g., smartphone), WiFi display techniques such as Miracast® often utilized a fixed length GOP to encode (and subsequently decode) the video data displayed at the source device. In some aspects, the use of a fixed length GOP can decrease the efficiency of video coding performed for WiFi display techniques such as Miracast®, based at least in part on the source device (e.g., smartphone) video display data varying in source, type, content, etc. There is a need for systems and techniques that can be used to perform variable length GOP video coding (e.g., variable I-frame time interval video coding) without using computationally intensive techniques such as video content analysis or motion analysis. There is also a need for systems and techniques that can be used to perform variable length GOP video coding (e.g., variable I-frame time interval video coding) in a power efficient manner that can be used to implement WiFi display sharing (e.g., Miracast®).

As described in more detail herein, systems, apparatuses, methods, and computer-readable media (collectively referred to as “systems and techniques”) are described herein for performing video coding using a variable intra-frame (I-frame) time interval and/or a variable length group of pictures (GOP) length. For example, the systems and techniques can perform video coding (e.g., encoding and/or decoding) using a variable I-frame interval and/or a variable GOP length that is determined based on information such as video frame layer information, video frame layer geometry, etc. For example, the systems and techniques can obtain and analyze layer information associated with one or more layers included in a plurality of frames to be encoded. In some aspects, the plurality of frames to be encoded can be captured by a smartphone or other mobile computing device used to perform wireless display sharing (e.g., Miracast®).

In some aspects, the one or more layers can be layer primitive types that represent composition work and interactions with a display hardware (e.g., a display or other display hardware associated with an encoding device, or other computing device). In some examples, a layer may also be referred to as a unit of composition. A layer can be a combination of a surface and an instance of a SurfaceControl. Each layer can have a set of properties that define how the layer interacts with other layers. For example, layer properties can include (but are not limited to) one or more of the layer properties described below.

A ‘Positional’ layer property can indicate where the layer appears on its corresponding display (e.g., a display is another type of primitive that, in combination with layers, can represent composition work and interactions with the display hardware). The ‘Positional’ layer property can include information such as the position(s) of a layer's edges and the layer's z-order relative to other layers (e.g., whether the layer is located in front of or behind other layers).

A ‘Content’ layer property can indicate how content display on the layer should be presented within the bounds of the layer (e.g., given by the positional properties). The ‘Content’ layer property can include information such as crop information (e.g., to expand a portion of the content to fill the bounds of the layer) and transform information (e.g., to show rotated or flipped content).

A ‘Composition’ layer property can indicate how the layer should be composited with other layers, and my include information such as a blending mode and a layer-wide alpha value for alpha compositing.

An ‘Optimization’ layer property can indicate or otherwise include information that may not be directly used to composite the layer, but that can be used by a hardware composer (HWC) to optimize its composition performance. For example, the ‘Optimization’ layer property can include information such as the visible region(s) of the layer and which portion(s) of the layer have been updated since the previous frame.

In some aspects, the layer information can include the geometry of individual layers, wherein each frame of captured display data associated with the source device includes one or more layers. In some cases, the layer information can include coordinate information, format information, etc., associated with individual layers of the frames of captured display data. In some aspects, the systems and techniques can use the layer information to determine an adaptive and/or variable length GOP (e.g., an adaptive and/or variable I-frame time interval). For example, the layer information can include rich scene information that can be analyzed more efficiently than a pixel-based content or motion analysis. Based on the rich scene information determined from the layer information, the systems and techniques can implement scene change analysis, notifications, and/or I-frame triggering.

For example, layer information of a current frame of captured display data from the source device can be analyzed and compared to layer information associated with one or more previous frames of captured display data from the source device. In some aspects, based on a determination that some (or all) of the layers represented in the layer information have changed by greater than a threshold amount or percentage (e.g., based on the frame geometry of the captured display data changing sufficiently), I-frame coding can be triggered and a new (e.g., variable or adaptive) GOP length can be applied to the newly generated I-frame. In some aspects, the systems and techniques described herein can perform adaptive and/or variable length GOP video coding (e.g., adaptive and/or variable I-frame time interval video coding) based on layer information, as described above, and further based on a display idle determination.

For example, the systems and techniques can determine that the video content represented in the frames of captured display data from the source device has transitioned to an idle state. In some aspects, the idle state can be associated with detecting no content change over a pre-determined period of time and/or detecting no additional rendering or refreshing of the frames of captured display data. In some examples, detecting or determining a display idle state can cause the systems and techniques to apply a new, relatively long GOP length that is associated with the display idle state. For example, the display idle GOP length can be 300 frames, although a greater or lesser number of frames may also be utilized for the display idle GOP length.

In some examples, each type of layer that may be included in a given frame of the captured display data from the source device can be associated with its own GOP length (e.g., in number of frames or time interval between I-frame key frames). In some aspects, each layer type can be associated with a different GOP length (e.g., in number of frames or time interval between I-frame key frames). In some cases, each layer type can be associated with its own GOP length, with one or more of the layer types being associated with the same GOP length value (e.g., in number of frames or time interval between I-frame key frames). In some examples, one or more (or all) of the layer type GOP lengths can be pre-determined. For example, the different layer type GOP lengths can be pre-determined based on a type of video content and/or a type of motion associated with each respective layer of the different layer types. In some aspects, a GOP length can be determined for a frame included in a plurality of frames of captured display data based on a primary content layer or primary content layer type associated with each given frame. For example, the frame GOP length can be adaptively or variable determined using the GOP length associated with the primary content layer determined for each given frame of the plurality of frames of captured display data.

Further details regarding the systems and techniques will be described with respect to the figures.

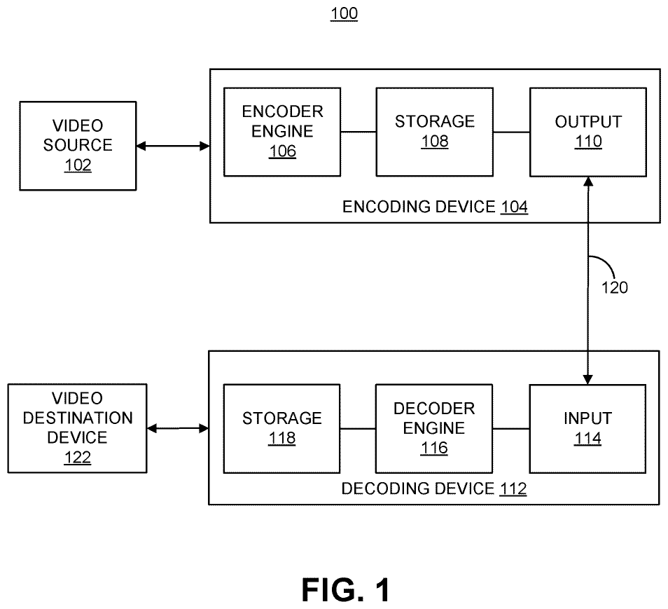

FIG. 1 is a block diagram illustrating an example of a system 100 including an encoding device 104 and a decoding device 112. The encoding device 104 may be part of a source device, and the decoding device 112 may be part of a receiving device. The source device and/or the receiving device may include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the source device and the receiving device may include one or more wireless transceivers for wireless communications. The coding techniques described herein are applicable to video coding in various multimedia applications, including streaming video transmissions (e.g., over the Internet), television broadcasts or transmissions, encoding of digital video for storage on a data storage medium, decoding of digital video stored on a data storage medium, or other applications. As used herein, the term coding can refer to encoding and/or decoding. In some examples, the system 100 can support one-way or two-way video transmission to support applications such as video conferencing, video streaming, video playback, video broadcasting, gaming, and/or video telephony.

The encoding device 104 (or encoder) can be used to encode video data using a video coding standard, format, codec, or protocol to generate an encoded video bitstream. Examples of video coding standards and formats/codecs include ITU-T H.261, ISO/IEC MPEG-1 Visual, ITU-T H.262 or ISO/IEC MPEG-2 Visual, ITU-T H.263, ISO/IEC MPEG-4 Visual, ITU-T H.264 (also known as ISO/IEC MPEG-4 AVC), including its Scalable Video Coding (SVC) and Multiview Video Coding (MVC) extensions, High Efficiency Video Coding (HEVC) or ITU-T H.265, and Versatile Video Coding (VVC) or ITU-T H.266. Various extensions to HEVC deal with multi-layer video coding exist, including the range and screen content coding extensions, 3D video coding (3D-HEVC) and multiview extensions (MV-HEVC) and scalable extension (SHVC). The HEVC and its extensions have been developed by the Joint Collaboration Team on Video Coding (JCT-VC) as well as Joint Collaboration Team on 3D Video Coding Extension Development (JCT-3V) of ITU-T Video Coding Experts Group (VCEG) and ISO/IEC Motion Picture Experts Group (MPEG). VP9, AOMedia Video 1 (AV1) developed by the Alliance for Open Media Alliance of Open Media (AOMedia), and Essential Video Coding (EVC) are other video coding standards for which the techniques described herein can be applied.

VVC, a latest video coding standard, was developed by Joint Video Experts Team (JVET) of ITU-T and ISO/IEC to, at least in part, achieve substantial compression capability beyond HEVC for a broad range of applications. The VVC specification was finalized in July 2020 and published by both ITU-T and ISO/IEC. The VVC specification specifies normative bitstream and picture formats, high level syntax (HLS) and coding unit level syntax, the parsing process, the decoding process, etc. VVC also specifies profiles/tiers/levels (PTL) restrictions, byte stream format, hypothetical reference decoder, and supplemental enhancement information (SEI) in the annex.

The systems and techniques described herein can be applied to any of the existing video codecs (e.g., VVC, HEVC, AVC, or other suitable existing video codec), and/or can be an efficient coding tool for any video coding standards being developed and/or future video coding standards. For example, examples described herein can be performed using video codecs such as VVC, HEVC, AVC, and/or extensions thereof. However, the techniques and systems described herein may also be applicable to other coding standards, codecs, or formats, such as MPEG, JPEG (or other coding standard for still images), VP9, AV1, extensions thereof, or other suitable coding standards already available or not yet available or developed. For instance, in some examples, the encoding device 104 and/or the decoding device 112 may operate according to a proprietary video codec/format, such as AV1, extensions of AV1, and/or successor versions of AV1 (e.g., AV2), or other proprietary formats or industry standards. Accordingly, while the techniques and systems described herein may be described with reference to a particular video coding standard, one of ordinary skill in the art will appreciate that the description should not be interpreted to apply only to that particular standard.

Referring to FIG. 1, a video source 102 may provide the video data to the encoding device 104. The video source 102 may be part of the source device or may be part of a device other than the source device. The video source 102 may include a video capture device (e.g., a video camera, a camera phone, a video phone, or the like), a video archive containing stored video, a video server or content provider providing video data, a video feed interface receiving video from a video server or content provider, a computer graphics system for generating computer graphics video data, a combination of such sources, or any other suitable video source.

The video data from the video source 102 may include one or more input pictures or frames. A picture or frame is a still image that, in some cases, is part of a video. In some examples, data from the video source 102 can be a still image that is not a part of a video. In HEVC, VVC, and other video coding specifications, a video sequence can include a series of pictures. A picture may include three sample arrays, denoted SL, SCb, and SCr. SL is a two-dimensional array of luma samples, SCb is a two-dimensional array of Cb chrominance samples, and SCr is a two-dimensional array of Cr chrominance samples. Chrominance samples may also be referred to herein as “chroma” samples. A pixel can refer to all three components (luma and chroma samples) for a given location in an array of a picture. In other instances, a picture may be monochrome and may only include an array of luma samples, in which case the terms pixel and sample can be used interchangeably. With respect to example techniques described herein that refer to individual samples for illustrative purposes, the same techniques can be applied to pixels (e.g., all three sample components for a given location in an array of a picture). With respect to example techniques described herein that refer to pixels (e.g., all three sample components for a given location in an array of a picture) for illustrative purposes, the same techniques can be applied to individual samples.

The encoder engine 106 (or encoder) of the encoding device 104 encodes the video data to generate an encoded video bitstream. In some examples, an encoded video bitstream (or “video bitstream” or “bitstream”) is a series of one or more coded video sequences. A coded video sequence (CVS) includes a series of access units (AUs) starting with an AU that has a random-access point picture in the base layer and with certain properties up to and not including a next AU that has a random-access point picture in the base layer and with certain properties. For example, the certain properties of a random-access point picture that starts a CVS may include a RASL flag (e.g., NoRaslOutputFlag) equal to 1. Otherwise, a random-access point picture (with RASL flag equal to 0) does not start a CVS. An access unit (AU) includes one or more coded pictures and control information corresponding to the coded pictures that share the same output time. Coded slices of pictures are encapsulated in the bitstream level into data units called network abstraction layer (NAL) units. For example, an HEVC video bitstream may include one or more CVSs including NAL units. Each of the NAL units has a NAL unit header. In one example, the header is one-byte for H.264/AVC (except for multi-layer extensions) and two-byte for HEVC. The syntax elements in the NAL unit header take the designated bits and therefore are visible to all kinds of systems and transport layers, such as Transport Stream, Real-time Transport (RTP) Protocol, File Format, among others.

Two classes of NAL units exist in the HEVC standard, including video coding layer (VCL) NAL units and non-VCL NAL units. A VCL NAL unit includes one slice or slice segment (described below) of coded picture data, and a non-VCL NAL unit includes control information that relates to one or more coded pictures. In some cases, a NAL unit can be referred to as a packet. An HEVC AU includes VCL NAL units containing coded picture data and non-VCL NAL units (if any) corresponding to the coded picture data.

NAL units may contain a sequence of bits forming a coded representation of the video data (e.g., an encoded video bitstream, a CVS of a bitstream, or the like), such as coded representations of pictures in a video. The encoder engine 106 generates coded representations of pictures by partitioning each picture into multiple slices. A slice is independent of other slices so that information in the slice is coded without dependency on data from other slices within the same picture. A slice includes one or more slice segments including an independent slice segment and, if present, one or more dependent slice segments that depend on previous slice segments. The slices are partitioned into coding tree blocks (CTBs) of luma samples and chroma samples. A CTB of luma samples and one or more CTBs of chroma samples, along with syntax for the samples, are referred to as a coding tree unit (CTU). A CTU may also be referred to as a “tree block” or a “largest coding unit” (LCU). A CTU is the basic processing unit for HEVC encoding. A CTU can be split into multiple coding units (CUs) of varying sizes. A CU contains luma and chroma sample arrays that are referred to as coding blocks (CBs).

The luma and chroma CBs can be further split into prediction blocks (PBs). A PB is a block of samples of the luma component or a chroma component that uses the same motion parameters for inter-prediction or intra-block copy prediction (when available or enabled for use). The luma PB and one or more chroma PBs, together with associated syntax, form a prediction unit (PU). For inter-prediction, a set of motion parameters (e.g., one or more motion vectors, reference indices, or the like) is signaled in the bitstream for each PU and is used for inter-prediction of the luma PB and the one or more chroma PBs. The motion parameters can also be referred to as motion information. A CB can also be partitioned into one or more transform blocks (TBs). A TB represents a square block of samples of a color component on which a residual transform (e.g., the same two-dimensional transform in some cases) is applied for coding a prediction residual signal. A transform unit (TU) represents the TBs of luma and chroma samples, and corresponding syntax elements.

A size of a CU corresponds to a size of the coding mode and may be square in shape. For example, a size of a CU may be 8×8 samples, 16×16 samples, 32×32 samples, 64×64 samples, or any other appropriate size up to the size of the corresponding CTU. The phrase “N×N” is used herein to refer to pixel dimensions of a video block in terms of vertical and horizontal dimensions (e.g., 8 pixels×8 pixels). The pixels in a block may be arranged in rows and columns. In some examples, blocks may not have the same number of pixels in a horizontal direction as in a vertical direction. Syntax data associated with a CU may describe, for example, partitioning of the CU into one or more PUs. Partitioning modes may differ between whether the CU is intra-prediction mode encoded or inter-prediction mode encoded. PUs may be partitioned to be non-square in shape. Syntax data associated with a CU may also describe, for example, partitioning of the CU into one or more TUs according to a CTU. A TU can be square or non-square in shape.

According to the HEVC standard, transformations may be performed using transform units (TUs). TUs may vary for different CUs. The TUs may be sized based on the size of PUs within a given CU. The TUs may be the same size or smaller than the PUs. In some examples, residual samples corresponding to a CU may be subdivided into smaller units using a quadtree structure known as residual quad tree (RQT). Leaf nodes of the RQT may correspond to TUs. Pixel difference values associated with the TUs may be transformed to produce transform coefficients. The transform coefficients may be quantized by the encoder engine 106.

Once the pictures of the video data are partitioned into CUs, the encoder engine 106 predicts each PU using a prediction mode. The prediction unit or prediction block is subtracted from the original video data to get residuals (described below). For each CU, a prediction mode may be signaled inside the bitstream using syntax data. A prediction mode may include intra-prediction (or intra-picture prediction) or inter-prediction (or inter-picture prediction). Intra-prediction utilizes the correlation between spatially neighboring samples within a picture. For example, using intra-prediction, each PU is predicted from neighboring image data in the same picture using, for example, DC prediction to find an average value for the PU, planar prediction to fit a planar surface to the PU, direction prediction to extrapolate from neighboring data, or any other suitable types of prediction. Inter-prediction uses the temporal correlation between pictures in order to derive a motion-compensated prediction for a block of image samples. For example, using inter-prediction, each PU is predicted using motion compensation prediction from image data in one or more reference pictures (before or after the current picture in output order). The decision whether to code a picture area using inter-picture or intra-picture prediction may be made, for example, at the CU level.

The encoder engine 106 and the decoder engine 116 (described in more detail below) may be configured to operate according to VVC. According to VVC, a video coder (such as the encoder engine 106 and/or the decoder engine 116) partitions a picture into a plurality of coding tree units (CTUs) (where a CTB of luma samples and one or more CTBs of chroma samples, along with syntax for the samples, are referred to as a CTU). The video coder can partition a CTU according to a tree structure, such as a quadtree-binary tree (QTBT) structure or Multi-Type Tree (MTT) structure. The QTBT structure removes the concepts of multiple partition types, such as the separation between CUs, PUs, and TUs of HEVC. A QTBT structure includes two levels, including a first level partitioned according to quadtree partitioning, and a second level partitioned according to binary tree partitioning. A root node of the QTBT structure corresponds to a CTU. Leaf nodes of the binary trees correspond to coding units (CUs).

In an MTT partitioning structure, blocks may be partitioned using a quadtree partition, a binary tree partition, and one or more types of triple tree partitions. A triple tree partition is a partition where a block is split into three sub-blocks. In some examples, a triple tree partition divides a block into three sub-blocks without dividing the original block through the center. The partitioning types in MTT (e.g., quadtree, binary tree, and tripe tree) may be symmetrical or asymmetrical.

When operating according to the AV1 codec, encoding device 104 and decoding device 112 may be configured to code video data in blocks. In AV1, the largest coding block that can be processed is called a superblock. In AV1, a superblock can be either 128×128 luma samples or 64×64 luma samples. However, in successor video coding formats (e.g., AV2), a superblock may be defined by different (e.g., larger) luma sample sizes. In some examples, a superblock is the top level of a block quadtree. Encoding device 104 may further partition a superblock into smaller coding blocks. Encoding device 104 may partition a superblock and other coding blocks into smaller blocks using square or non-square partitioning. Non-square blocks may include N/2×N, N×N/2, N/4×N, and N×N/4 blocks. Encoding device 104 and decoding device 112 may perform separate prediction and transform processes on each of the coding blocks.

AV1 also defines a tile of video data. A tile is a rectangular array of superblocks that may be coded independently of other tiles. That is, encoding device 104 and decoding device 112 may encode and decode, respectively, coding blocks within a tile without using video data from other tiles. However, encoding device 104 and decoding device 112 may perform filtering across tile boundaries. Tiles may be uniform or non-uniform in size. Tile-based coding may enable parallel processing and/or multi-threading for encoder and decoder implementations.

In some examples, the encoding device 104 and decoding device 112 can use a single QTBT or MTT structure to represent each of the luminance and chrominance components, while in other examples, the video coder can use two or more QTBT or MTT structures, such as one QTBT or MTT structure for the luminance component and another QTBT or MTT structure for both chrominance components (or two QTBT and/or MTT structures for respective chrominance components).

The encoding device 104 and decoding device 112 can be configured to use quadtree partitioning per HEVC, QTBT partitioning, MTT partitioning, or other partitioning structures.

In some examples, the one or more slices of a picture are assigned a slice type. Slice types include an I slice, a P slice, and a B slice. An I slice (intra-frames, independently decodable) is a slice of a picture that is only coded by intra-prediction, and therefore is independently decodable since the I slice requires only the data within the frame to predict any prediction unit or prediction block of the slice. A P slice (uni-directional predicted frames) is a slice of a picture that may be coded with intra-prediction and with uni-directional inter-prediction. Each prediction unit or prediction block within a P slice is either coded with intra prediction or inter-prediction. When the inter-prediction applies, the prediction unit or prediction block is only predicted by one reference picture, and therefore reference samples are only from one reference region of one frame. A B slice (bi-directional predictive frames) is a slice of a picture that may be coded with intra-prediction and with inter-prediction (e.g., either bi-prediction or uni-prediction). A prediction unit or prediction block of a B slice may be bi-directionally predicted from two reference pictures, where each picture contributes one reference region and sample sets of the two reference regions are weighted (e.g., with equal weights or with different weights) to produce the prediction signal of the bi-directional predicted block. As explained above, slices of one picture are independently coded. In some cases, a picture can be coded as just one slice.

As noted above, intra-picture prediction utilizes the correlation between spatially neighboring samples within a picture. There is a plurality of intra-prediction modes (also referred to as “intra modes”). In some examples, the intra prediction of a luma block includes 35 modes, including the Planar mode, DC mode, and 33 angular modes (e.g., diagonal intra-prediction modes and angular modes adjacent to the diagonal intra-prediction modes). The encoding device 104 and/or the decoding device 112 may select the prediction mode for each block that minimizes the residual between the prediction block and the block to be encoded (e.g., based on a Sum of Absolute Errors (SAE), Sum of Absolute Differences (SAD), Sum of Absolute Transformed Differences (SATD), or other measure of similarity). For instance, the SAE can be calculated by taking the absolute difference between each pixel (or sample) in the block to be encoded and the corresponding pixel (or sample) in the prediction block being used for comparison. The differences of the pixels (or samples) are summed to create a metric of block similarity, such as the L1 norm of the difference image, the Manhattan distance between two image blocks, or other calculation. Using SAE as an example, the SAE for each prediction using each of the intra-prediction modes indicates the magnitude of the prediction error. The intra-prediction mode that has the best match to the actual current block is given by the intra-prediction mode that gives the smallest SAE.

The 35 modes of the intra prediction are indexed as shown in Table 1 below. In other examples, more intra modes may be defined including prediction angles that may not already be represented by the 33 angular modes. In other examples, the prediction angles associated with the angular modes may be different from those used in HEVC.

TABLE 1
Specification of intra-prediction mode and associated names

| Intra- | |
|---|---|
| prediction mode | Associated name |
| 0 | INTRA_PLANAR |
| 1 | INTRA_DC |
| 2 . . . 34 | INTRA_ANGULAR2 . . . INTRA_ANGULAR34 |

To perform Planar prediction for an N×N block, for each sample pxy located at (x, y), the prediction sample value may be calculated by applying a bilinear filter to four specific neighboring reconstructed samples (used as reference samples for intra prediction). The four reference samples include the top-right reconstructed sample TR, the bottom-left reconstructed sample BL, and the two reconstructed samples located at the same column (r_{x,-1}) and row (r_{-1,y}) of the current sample. The Planar mode can be formulated as below:

$${p}_{x y} = ( N - x 1 ) ⋆ \cdot L + ( N - y 1 ) * \cdot T + x 1 * \cdot R + y 1 * \cdot B ) / ( 2 ⋆ N ) ,$$

where x1=x+1, y1−y+1, R=TR and B=BL.

For DC mode, the prediction block is filled with the average value of the neighboring reconstructed samples. Generally, both Planar and DC modes are applied for modeling smoothly varying and constant image regions.

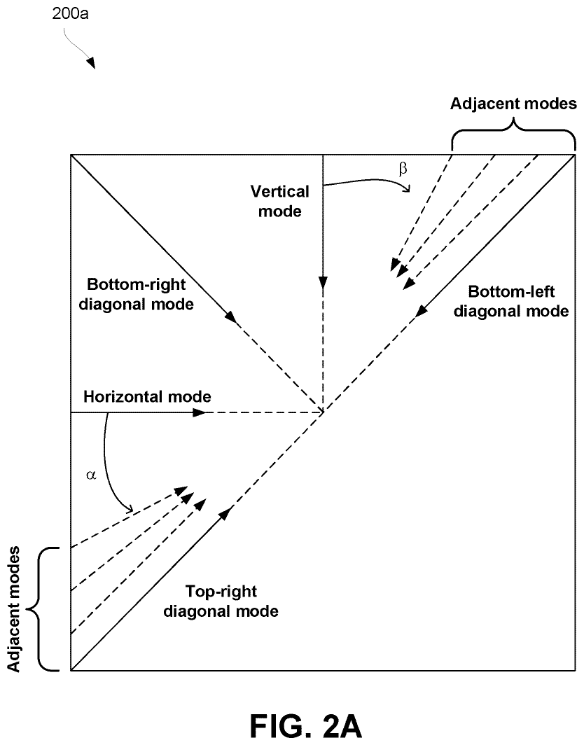

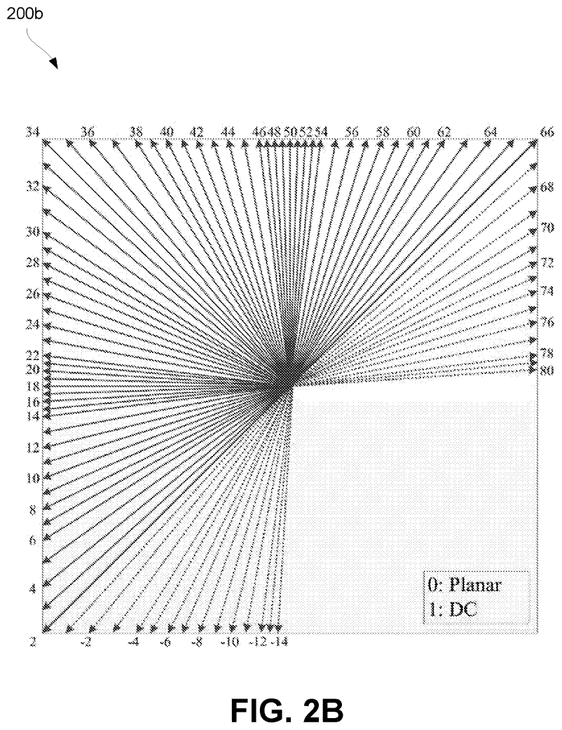

For angular intra-prediction modes in HEVC, which include 33 different prediction directions, the intra prediction process can be described as follows. For each given angular intra-prediction mode, the intra-prediction direction can be identified accordingly; for example, intra mode 18 corresponds to a pure horizontal prediction direction, and intra mode 26 corresponds to a pure vertical prediction direction. Angular prediction modes are shown in the example diagram 200a of FIG. 2A. In some codecs, a different number of intra-prediction modes may be used. For example, in addition to Planar and DC modes, 93 angular modes may be defined, where mode 2 indicates a prediction direction of −135°, mode 34 indicates a prediction direction of −45°, and mode 66 indicates a prediction direction of 45°. In some codecs (e.g., VVC), angles beyond −135° (less than) −135° and beyond 45° (more than) 45° may also be defined; these may be referred to as wide-angled intra modes. Although the description herein is with respect to the intra mode design in HEVC (e.g., with 35 modes), the techniques disclosed may also apply to more intra modes (e.g., the intra modes defined by VVC or other codec).

Coordinates (x,y) of each sample of a prediction block are projected along a specific intra prediction direction (e.g., one of the angular intra-prediction modes). For example, given a specific intra prediction direction, the coordinates (x, y) of a sample of the prediction block are first projected to the row/column of neighboring reconstructed samples along the intra prediction direction. In cases when (x,y) is projected to the fractional position a between two neighboring reconstructed samples L and R; then the prediction value for (x, y) may be calculated using a two-tap bi-linear interpolation filter, formulated as follows:

$${p}_{x y} = ( 1 - a ) \cdot L + a \cdot R$$

To avoid floating point operations, in HEVC, the above calculation may be approximated using integer arithmetic as:

$${p}_{x y} = ( ( 32 - {a}^{′} ) \cdot L + {a}^{′} \cdot R + 16 ) >> 5 ,$$

where a′ is an integer equal to 32*a.

In some examples, before intra prediction, the neighboring reference samples are filtered using a 2-Tap bilinear or 3-Tap (1,2,1)/4 filter, which can be referred to as intra reference smoothing or mode-dependent intra smoothing (MDIS). When performing intra prediciton, given the intra-prediction mode index (predModeIntra) and block size (nTbS), it is decided whether a reference smoothing process is performed and which smoothing filter is used. The intra-prediction mode index is an index indicating an intra-prediction mode.

Inter-picture prediction uses the temporal correlation between pictures in order to derive a motion-compensated prediction for a block of image samples. Using a translational motion model, the position of a block in a previously decoded picture (a reference picture) is indicated by a motion vector (Δx, Δy), with Δx specifying the horizontal displacement and Δy specifying the vertical displacement of the reference block relative to the position of the current block. In some cases, a motion vector (Δx, Δy) can be in integer sample accuracy (also referred to as integer accuracy), in which case the motion vector points to the integer-pel grid (or integer-pixel sampling grid) of the reference frame. In some cases, a motion vector (Δx, Δy) can be of fractional sample accuracy (also referred to as fractional-pel accuracy or non-integer accuracy) to more accurately capture the movement of the underlying object, without being restricted to the integer-pel grid of the reference frame. Accuracy of motion vectors may be expressed by the quantization level of the motion vectors. For example, the quantization level may be integer accuracy (e.g., 1-pixel) or fractional-pel accuracy (e.g., ¼-pixel, ½-pixel, or other sub-pixel value). Interpolation is applied on reference pictures to derive the prediction signal when the corresponding motion vector has fractional sample accuracy. For example, samples available at integer positions can be filtered (e.g., using one or more interpolation filters) to estimate values at fractional positions. The previously decoded reference picture is indicated by a reference index (refIdx) to a reference picture list. The motion vectors and reference indices can be referred to as motion parameters. Two kinds of inter-picture prediction can be performed, including uni-prediction and bi-prediction.

With inter-prediction using bi-prediction (also referred to as bi-directional inter-prediction), two sets of motion parameters (Δx₀, y₀, refIdx₀, and Δx₁, y₁, refIdx₁) are used to generate two motion compensated predictions (from the same reference picture or possibly from different reference pictures). For example, with bi-prediction, each prediction block uses two motion compensated prediction signals, and generates B prediction units. The two motion compensated predictions are combined to get the final motion compensated prediction. For example, the two motion compensated predictions can be combined by averaging. In another example, weighted prediction can be used, in which case different weights can be applied to each motion compensated prediction. The reference pictures that can be used in bi-prediction are stored in two separate lists, denoted as list 0 and list 1. Motion parameters can be derived at the encoding device 104 using a motion estimation process.

With inter-prediction using uni-prediction (also referred to as uni-directional inter-prediction), one set of motion parameters (Δx₀, y₀, refIdx₀) is used to generate a motion compensated prediction from a reference picture. For example, with uni-prediction, each prediction block uses at most one motion compensated prediction signal, and generates P prediction units.

A PU may include the data (e.g., motion parameters or other suitable data) related to the prediction process. For example, when the PU is encoded using intra-prediction, the PU may include data describing an intra-prediction mode for the PU. As another example, when the PU is encoded using inter-prediction, the PU may include data defining a motion vector for the PU. The data defining the motion vector for a PU may describe, for example, a horizontal component of the motion vector (Δx), a vertical component of the motion vector (Δy), a resolution for the motion vector (e.g., integer precision, one-quarter pixel precision or one-eighth pixel precision), a reference picture to which the motion vector points, a reference index, a reference picture list (e.g., List 0, List 1, or List C) for the motion vector, or any combination thereof.

AV1 includes two general techniques for encoding and decoding a coding block of video data. The two general techniques are intra prediction (e.g., intra frame prediction or spatial prediction) and inter prediction (e.g., inter frame prediction or temporal prediction). In the context of AV1, when predicting blocks of a current frame of video data using an intra prediction mode, encoding device 104 and decoding device 112 do not use video data from other frames of video data. For most intra prediction modes, the video encoding device 104 encodes blocks of a current frame based on the difference between sample values in the current block and predicted values generated from reference samples in the same frame. The video encoding device 104 determines predicted values generated from the reference samples based on the intra prediction mode.

After performing prediction using intra- and/or inter-prediction, the encoding device 104 can perform transformation and quantization. For example, following prediction, the encoder engine 106 may calculate residual values corresponding to the PU. Residual values may comprise pixel difference values between the current block of pixels being coded (the PU) and the prediction block used to predict the current block (e.g., the predicted version of the current block). For example, after generating a prediction block (e.g., issuing inter-prediction or intra-prediction), the encoder engine 106 can generate a residual block by subtracting the prediction block produced by a prediction unit from the current block. The residual block includes a set of pixel difference values that quantify differences between pixel values of the current block and pixel values of the prediction block. In some examples, the residual block may be represented in a two-dimensional block format (e.g., a two-dimensional matrix or array of pixel values). In such examples, the residual block is a two-dimensional representation of the pixel values.

Any residual data that may be remaining after prediction is performed is transformed using a block transform, which may be based on discrete cosine transform, discrete sine transform, an integer transform, a wavelet transform, other suitable transform function, or any combination thereof. In some cases, one or more block transforms (e.g., sizes 32×32, 16×16, 8×8, 4×4, or other suitable size) may be applied to residual data in each CU. In some examples, a TU may be used for the transform and quantization processes implemented by the encoder engine 106. A given CU having one or more PUs may also include one or more TUs. As described in further detail below, the residual values may be transformed into transform coefficients using the block transforms, and may be quantized and scanned using TUs to produce serialized transform coefficients for entropy coding.

In some examples, following intra-predictive or inter-predictive coding using PUs of a CU, the encoder engine 106 may calculate residual data for the TUs of the CU. The PUs may comprise pixel data in the spatial domain (or pixel domain). The TUs may comprise coefficients in the transform domain following application of a block transform. As previously noted, the residual data may correspond to pixel difference values between pixels of the unencoded picture and prediction values corresponding to the PUs. The encoder engine 106 may form the TUs including the residual data for the CU, and may transform the TUs to produce transform coefficients for the CU.

The encoder engine 106 may perform quantization of the transform coefficients. Quantization provides further compression by quantizing the transform coefficients to reduce the amount of data used to represent the coefficients. For example, quantization may reduce the bit depth associated with some or all of the coefficients. In one example, a coefficient with an n-bit value may be rounded down to an m-bit value during quantization, with n being greater than m.

Once quantization is performed, the coded video bitstream includes quantized transform coefficients, prediction information (e.g., prediction modes, motion vectors, block vectors, or the like), partitioning information, and any other suitable data, such as other syntax data. The different elements of the coded video bitstream may be entropy encoded by the encoder engine 106. In some examples, the encoder engine 106 may utilize a predefined scan order to scan the quantized transform coefficients to produce a serialized vector that can be entropy encoded. In some examples, the encoder engine 106 may perform an adaptive scan. After scanning the quantized transform coefficients to form a vector (e.g., a one-dimensional vector), the encoder engine 106 may entropy encode the vector. For example, the encoder engine 106 may use context adaptive variable length coding, context adaptive binary arithmetic coding, syntax-based context-adaptive binary arithmetic coding, probability interval partitioning entropy coding, or another suitable entropy encoding technique.

The output 110 of the encoding device 104 may send the NAL units making up the encoded video bitstream data over the communication link 120 to the decoding device 112 of the receiving device. The input 114 of the decoding device 112 may receive the NAL units. The communication link 120 may include a channel provided by a wireless network, a wired network, or a combination of a wired and wireless network. A wireless network may include any wireless interface or combination of wireless interfaces and may include any suitable wireless network (e.g., the Internet or other wide area network, a packet-based network, WiFi™, radio frequency (RF), UWB, WiFi-Direct, cellular, Long-Term Evolution (LTE), WiMax™, or the like). A wired network may include any wired interface (e.g., fiber, ethernet, powerline ethernet, ethernet over coaxial cable, digital signal line (DSL), or the like). The wired and/or wireless networks may be implemented using various equipment, such as base stations, routers, access points, bridges, gateways, switches, or the like. The encoded video bitstream data may be modulated according to a communication standard, such as a wireless communication protocol, and transmitted to the receiving device.

In some examples, the encoding device 104 may store encoded video bitstream data in a storage 108. The output 110 may retrieve the encoded video bitstream data from the encoder engine 106 or from the storage 108. The storage 108 may include any of a variety of distributed or locally accessed data storage media. For example, the storage 108 may include a hard drive, a storage disc, flash memory, volatile or non-volatile memory, or any other suitable digital storage media for storing encoded video data. The storage 108 can also include a decoded picture buffer (DPB) for storing reference pictures for use in inter-prediction. In a further example, the storage 108 can correspond to a file server or another intermediate storage device that may store the encoded video generated by the source device. In such cases, the receiving device including the decoding device 112 can access stored video data from the storage device via streaming or download. The file server may be any type of server capable of storing encoded video data and transmitting that encoded video data to the receiving device. Example file servers include a web server (e.g., for a website), an FTP server, network attached storage (NAS) devices, or a local disk drive. The receiving device may access the encoded video data through any standard data connection, including an Internet connection, and may include a wireless channel (e.g., a Wi-Fi connection), a wired connection (e.g., DSL, cable modem, etc.), or a combination of both that is suitable for accessing encoded video data stored on a file server. The transmission of encoded video data from the storage 108 may be a streaming transmission, a download transmission, or a combination thereof.

The input 114 of the decoding device 112 receives the encoded video bitstream data and may provide the video bitstream data to the decoder engine 116, or to the storage 118 for later use by the decoder engine 116. For example, the storage 118 can include a DPB for storing reference pictures for use in inter-prediction. The receiving device including the decoding device 112 can receive the encoded video data to be decoded via the storage 108. The encoded video data may be modulated according to a communication standard, such as a wireless communication protocol, and transmitted to the receiving device. The communication medium for transmitted the encoded video data can comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from the source device to the receiving device.

The decoder engine 116 may decode the encoded video bitstream data by entropy decoding (e.g., using an entropy decoder) and extracting the elements of one or more coded video sequences making up the encoded video data. The decoder engine 116 may rescale and perform an inverse transform on the encoded video bitstream data. Residual data is passed to a prediction stage of the decoder engine 116. The decoder engine 116 predicts a block of pixels (e.g., a PU). In some examples, the prediction is added to the output of the inverse transform (the residual data).

The decoding device 112 may output the decoded video to a video destination device 122, which may include a display or other output device for displaying the decoded video data to a consumer of the content. In some aspects, the video destination device 122 may be part of the receiving device that includes the decoding device 112. In some aspects, the video destination device 122 may be part of a separate device other than the receiving device.

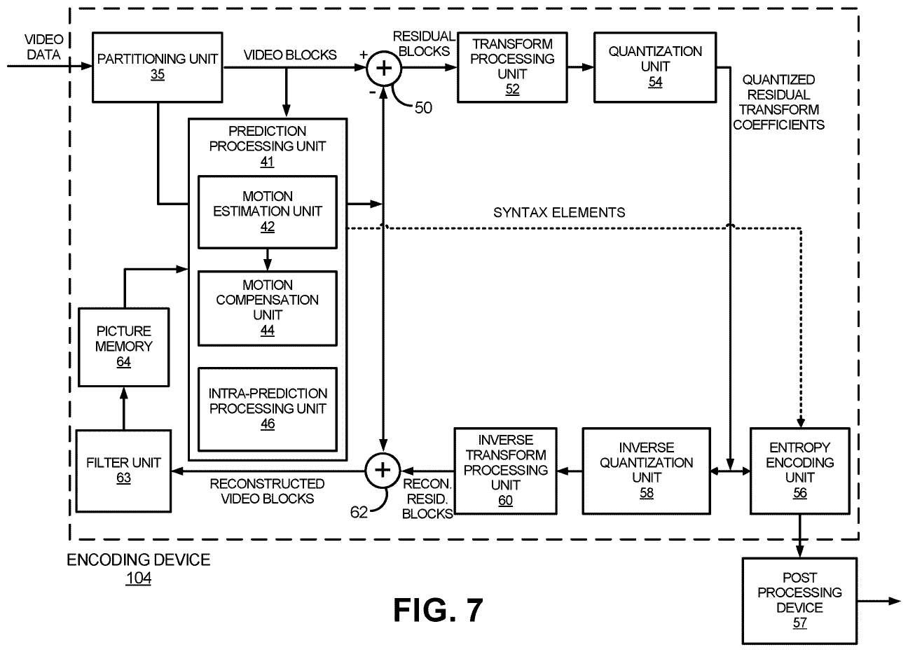

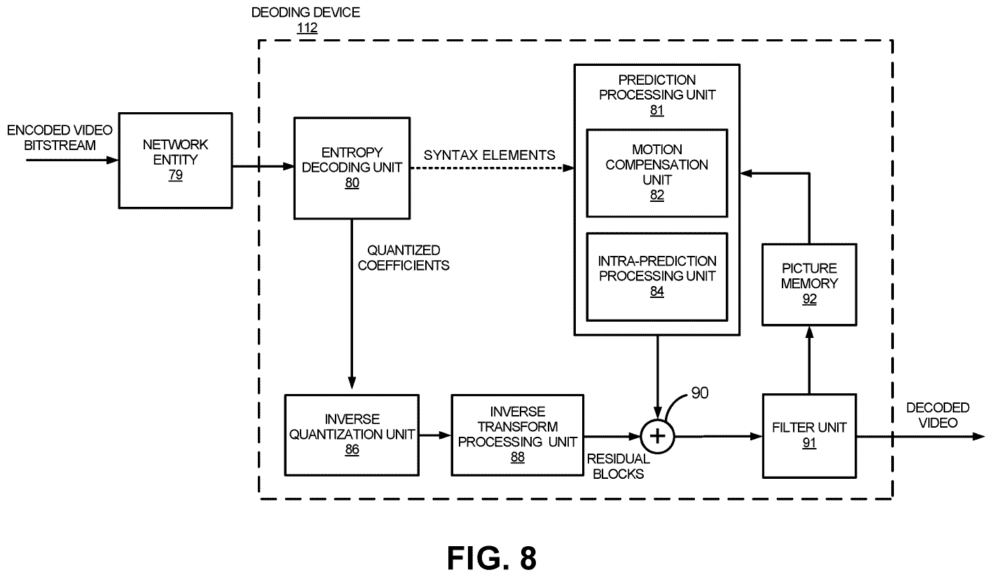

In some examples, the video encoding device 104 and/or the video decoding device 112 may be integrated with an audio encoding device and audio decoding device, respectively. The video encoding device 104 and/or the video decoding device 112 may also include other hardware or software that is necessary to implement the coding techniques described above, such as one or more microprocessors, digital signal processors (DSPs), application specific integrated circuits (ASICs), field programmable gate arrays (FPGAs), discrete logic, software, hardware, firmware or any combinations thereof. The video encoding device 104 and the video decoding device 112 may be integrated as part of a combined encoder/decoder (codec) in a respective device. An example of specific details of the encoding device 104 is described below with reference to FIG. 7. An example of specific details of the decoding device 112 is described below with reference to FIG. 8.

The example system shown in FIG. 1 is one illustrative example that can be used herein. Techniques for processing video data using the techniques described herein can be performed by any digital video encoding and/or decoding device. Although generally the techniques of this disclosure are performed by a video encoding device or a video decoding device, the techniques may also be performed by a combined video encoder-decoder, typically referred to as a “CODEC.” Moreover, the techniques of this disclosure may also be performed by a video preprocessor. The source device and the receiving device are merely examples of such coding devices in which the source device generates coded video data for transmission to the receiving device. In some examples, the source and receiving devices may operate in a substantially symmetrical manner such that each of the devices include video encoding and decoding components. Hence, example systems may support one-way or two-way video transmission between video devices, e.g., for video streaming, video playback, video broadcasting, or video telephony.

As previously described, an HEVC bitstream includes a group of NAL units, including VCL NAL units and non-VCL NAL units. VCL NAL units include coded picture data forming a coded video bitstream. For example, a sequence of bits forming the coded video bitstream is present in VCL NAL units. Non-VCL NAL units may contain parameter sets with high-level information relating to the encoded video bitstream, in addition to other information. For example, a parameter set may include a video parameter set (VPS), a sequence parameter set (SPS), and a picture parameter set (PPS). Examples of goals of the parameter sets include bit rate efficiency, error resiliency, and providing systems layer interfaces. Each slice references a single active PPS, SPS, and VPS to access information that the decoding device 112 may use for decoding the slice. An identifier (ID) may be coded for each parameter set, including a VPS ID, an SPS ID, and a PPS ID. An SPS includes an SPS ID and a VPS ID. A PPS includes a PPS ID and an SPS ID. Each slice header includes a PPS ID. Using the IDs, active parameter sets can be identified for a given slice.

A PPS includes information that applies to all slices in a given picture. In some examples, all slices in a picture refer to the same PPS. Slices in different pictures may also refer to the same PPS. An SPS includes information that applies to all pictures in a same coded video sequence (CVS) or bitstream. As previously described, a coded video sequence is a series of access units (AUS) that starts with a random access point picture (e.g., an instantaneous decode reference (IDR) picture or broken link access (BLA) picture, or other appropriate random access point picture) in the base layer and with certain properties (described above) up to and not including a next AU that has a random access point picture in the base layer and with certain properties (or the end of the bitstream). The information in an SPS may not change from picture to picture within a coded video sequence. Pictures in a coded video sequence may use the same SPS. The VPS includes information that applies to all layers within a coded video sequence or bitstream. The VPS includes a syntax structure with syntax elements that apply to entire coded video sequences. In some examples, the VPS, SPS, or PPS may be transmitted in-band with the encoded bitstream. In some examples, the VPS, SPS, or PPS may be transmitted out-of-band in a separate transmission than the NAL units containing coded video data.

This disclosure may generally refer to “signaling” certain information, such as syntax elements. The term “signaling” may generally refer to the communication of values for syntax elements and/or other data used to decode encoded video data. For example, the video encoding device 104 may signal values for syntax elements in the bitstream. In general, signaling refers to generating a value in the bitstream. As noted above, video source 102 may transport the bitstream to video destination device 122 substantially in real time, or not in real time, such as might occur when storing syntax elements to storage 108 for later retrieval by the video destination device 122.

A video bitstream can also include Supplemental Enhancement Information (SEI) messages. For example, an SEI NAL unit can be part of the video bitstream. In some cases, an SEI message can contain information that is not needed by the decoding process. For example, the information in an SEI message may not be essential for the decoder to decode the video pictures of the bitstream, but the decoder can use the information to improve the display or processing of the pictures (e.g., the decoded output). The information in an SEI message can be embedded metadata. In one illustrative example, the information in an SEI message could be used by decoder-side entities to improve the viewability of the content. In some instances, certain application standards may mandate the presence of such SEI messages in the bitstream so that the improvement in quality can be brought to all devices that conform to the application standard (e.g., the carriage of the frame-packing SEI message for frame-compatible plano-stereoscopic 3DTV video format, where the SEI message is carried for every frame of the video, handling of a recovery point SEI message, use of pan-scan scan rectangle SEI message in DVB, in addition to many other examples).

As noted above, the encoding device 104 may encode one or more blocks or rectangular regions of a picture of an original video sequence by using intra-prediction and/or intra-frame prediction to remove spatial redundancy. The decoding device 112 can decode an encoded block by using the same intra-prediction mode that was used by the encoding device 104. Intra-prediction modes describe different variants or approaches for calculating pixel values in the area being coded based on reference pixel values. In the VVC standard, one or more smoothing filters and interpolation filters can be selected based on the intra-prediction mode and subsequently applied to the reference pixels and/or the intra-prediction of the current block. In this approach, the same choice between smoothing filters and interpolation filters used for intra-prediction is applied for all block sizes, e.g., a fixed degree of smoothing is applied for all possible block sizes. Different directional intra-prediction modes are provided in the VVC standard.

FIG. 2B illustrates an example diagram 200b of the directional intra-prediction modes (also referred to as “angular intra-prediction modes”) in VVC. In some examples, the planar and DC modes remain the same in VVC as they were in HEVC. As illustrated, the intra-prediction modes with even indices between 2 and 66 can be equivalent to the 33 HEVC intra-prediction modes, with the remaining intra-prediction modes of FIG. 2B representing the newly added intra-prediction modes in VVC. As an illustrative example, to better capture the arbitrary edge directions presented in natural video, the number of directional intra-prediction modes in VTM5 (VVC Test Model 5) was increased to a total of 93 directions from the 33 HEVC directions. The intra-prediction modes are described in more detail in B. Bross, J. Chen, S. Liu, “Versatile Video Coding (Draft 10),” 19th JVET Meeting, Teleconference, July 2020, JVET-S2001, which is hereby incorporated by reference in its entirety and for all purposes. In some examples, the denser directional intra-prediction modes introduced in the VVC standard can be applied for all block sizes and for both luma and chroma intra predictions. In some cases, these directional intra-prediction modes can be either used in combination with multiple reference lines (MRL), and/or with an intra-sub partition mode (ISP). Further details are described in J. Chen, Y. Ye, S. Kim, “Algorithm description for Versatile Video Coding and Test Model 10 (VTM10),” 19th JVET Meeting, Teleconference, July 2020, JVET-S2002, which is hereby incorporated by reference in its entirety and for all purposes.

As noted previously, video coding can be performed using a combination of intra-prediction frames (I-frames), predicted frames (P-frames), and/or bi-directional frames (B-frames). In some aspects, I-frames can be used as key frames for coding (e.g., encoding or decoding) a plurality of frames of video data. For example, I-frames can be used as key frames for encoding or decoding a plurality of frames of captured video display data, as will be described in greater depth below.

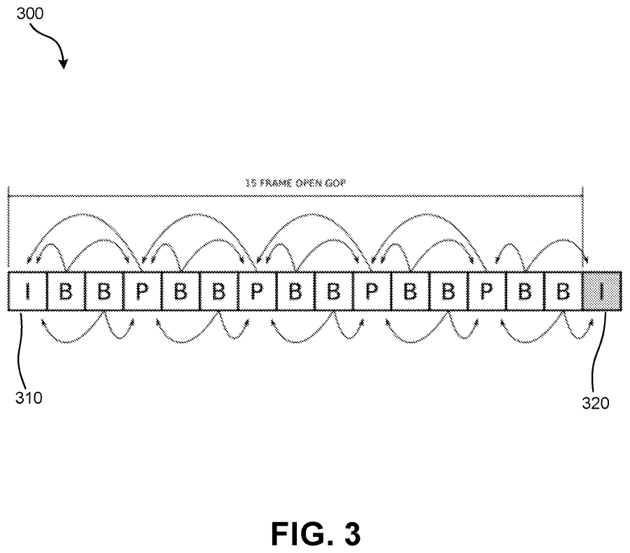

FIG. 3 is a diagram illustrating an example of a group of pictures (GOP) length and an inter-frame (I-frame) time interval that can be used to code (e.g., encode and/or decode) a plurality of frames of video data. For example, FIG. 3 depicts a plurality of frames of video data 300 that includes a first I-frame 310 and a second I-frame 320. In some aspects, the I-frames 310 and 320 can be utilized as key frames for coding one or more B-frames and/or one or more P-frames that are sequentially located before or after the I-frame. For example, the I-frames 310 and 320 can be utilized as key frames for the plurality of P-frames and B-frames that are also included in the plurality of frames of video data 300. In some aspects, the I-frames 310 and 320 may be utilized as key frames based on the I-frames 310 and 320 including only blocks of video data that are referenced to other blocks of video data within the same I-frame.

In some aspects, P-frames can be generated to refer to an I-frame key frame that was previously encoded. For example, one or more (or all) of the four P-frames depicted in FIG. 3 can be generated to refer to the first I-frame 310 as a key frame (e.g., based on first I-frame 310 being generated or encoded prior to any of the four P-frames included in the plurality of frames of video data 300). In some examples, one or more (or all) of the ten B-frames depicted in FIG. 3 can be generated to refer to the first I-frame 310 as a key frame, can be generated to refer to the second I-frame 320 as a key frame, or can be generated to refer to both the first I-frame 310 and the second I-frame 320 as key frames.

The distance between two key frames (e.g., between the two I-frames 310, 320) can be referred to as a group of pictures (GOP) length and/or an I-frame time interval. For example, the plurality of frames 300 includes the first I-frame 310, fourteen intermediate frames (e.g., each of which is a P-frame or a B-frame), and the second I-frame 320. In some aspects, an open GOP length associated with the plurality of frames 300 is 15 frames. For example, the open GOP length of 15 frames can be determined as the fourteen P-frames and B-frames plus the first I-frame 310 (e.g., first I-frame 310 and the fourteen P-frames and B-frames comprise a group of pictures (GOP) with a length of 1+14=15 frames). In some aspects, the open GOP length of 15 frames can be determined as the fourteen P-frames and B-frames plus the next I-frame (e.g., second I-frame 320). For example, the open GOP length of 15 frames can be used to indicate that the next I-frame (e.g., key frame) after the first I-frame 310 (e.g., first key frame) will be located 15 frames after the first I-frame 310. In some cases, a closed GOP length can be determined as the quantity of intermediate frames (e.g., P-frames and/or B-frames) that are located between two I-frames, wherein the closed GOP length is determined exclusive of the frame(s) occupied by the respective I-frame(s) associated with the calculation. For example, the plurality of frames 300 can be associated with a closed GOP length of 14 frames.

As mentioned previously, GOP length can measure the distance between two key frames (e.g., I-frames) in a series of video frames (e.g., such as the plurality of video frames 300). In one illustrative example, a GOP length may also be referred to herein as an I-frame time interval. GOP length (e.g., or I-frame interval) can be measured in a number or quantity of frames between I-frames (e.g., as described above) and/or can be measured as an amount of time between I-frames. For example, in the case of the plurality of video frames 300 illustrated in FIG. 3, an I-frame may be inserted and used as a key frame for every 15 frames of video. If the plurality of video frames 300 are associated with a playback speed of 30 frames per second (fps), the GOP length may also be measured as 0.5 seconds (e.g., two I-frame key frames per one second of video).

In some examples, the efficiency and/or performance of video coding can be improved based on using a variable I-frame time interval (e.g., a “variable GOP length”). In some aspects, improved video coding efficiency for different types of video content may be associated with different GOP lengths. For example, a relatively static video content can be coded using a relatively large GOP length (e.g., based on the video content changing relatively little over time), while a video content with rapid movements or many moving objects may be coded using a relatively small GOP length (e.g., based on the video content changing relatively rapidly over time).

In some examples, variable length GOP video coding can be performed based on video content analysis and/or motion analysis. For example, video content analysis and/or motion analysis can be performed to determine an amount of change (e.g., over time) that is associated with the video content. Such techniques can achieve improved video coding performance may often be associated with a high computational complexity and power consumption. For example, computational complexity and power consumption can be increased based on performing a video content analysis and/or motion analysis separate from the video coding.

In some cases, fixed length GOP video coding (e.g., fixed I-frame time interval video coding) may be utilized based on computational constraints, power constraints, and/or coding time constraints associated with a given video coding device. For example, wireless display sharing and/or WiFi display techniques (e.g., such as Miracast®) can be used to wirelessly share video content between WiFi devices by capturing and encoding the display contents of a source device (e.g., a smartphone) and transmitting the encoded video data to a receiving device (e.g., a television). Based on the computational resources and/or the power and energy resources available at the source device (e.g., smartphone), WiFi display techniques such as Miracast® often utilized a fixed length GOP to encode (and subsequently decode) the video data displayed at the source device. In some aspects, the use of a fixed length GOP can decrease the efficiency of video coding performed for WiFi display techniques such as Miracast®, based at least in part on the source device (e.g., smartphone) video display data varying in source, type, content, etc. There is a need for systems and techniques that can be used to perform variable length GOP video coding (e.g., variable I-frame time interval video coding) without using computationally intensive techniques such as video content analysis or motion analysis. There is also a need for systems and techniques that can be used to perform variable length GOP video coding (e.g., variable I-frame time interval video coding) in a power efficient manner that can be used to implement WiFi display sharing (e.g., Miracast®).

As described in more detail below, systems and techniques are provided for performing video coding using a variable intra-frame (I-frame) time interval and/or a variable length group of pictures (GOP) length. For example, the systems and techniques can perform video coding (e.g., encoding and/or decoding) using a variable I-frame interval and/or a variable GOP length that is determined based on information such as video frame layer information, video frame layer geometry, etc. For example, the systems and techniques can obtain and analyze layer information associated with one or more layers included in a plurality of frames to be encoded. In some aspects, the plurality of frames to be encoded can be captured by a smartphone or other mobile computing device used to perform wireless display sharing (e.g., Miracast®).

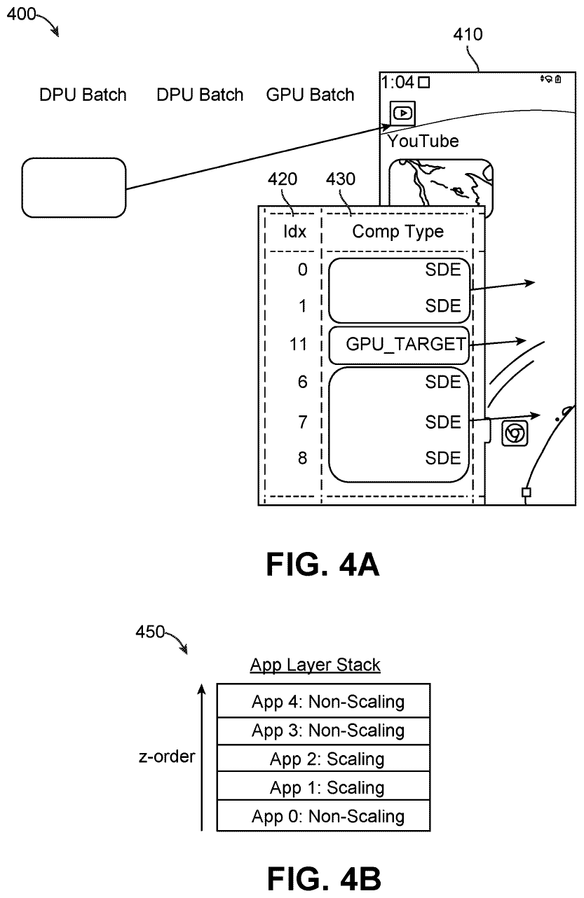

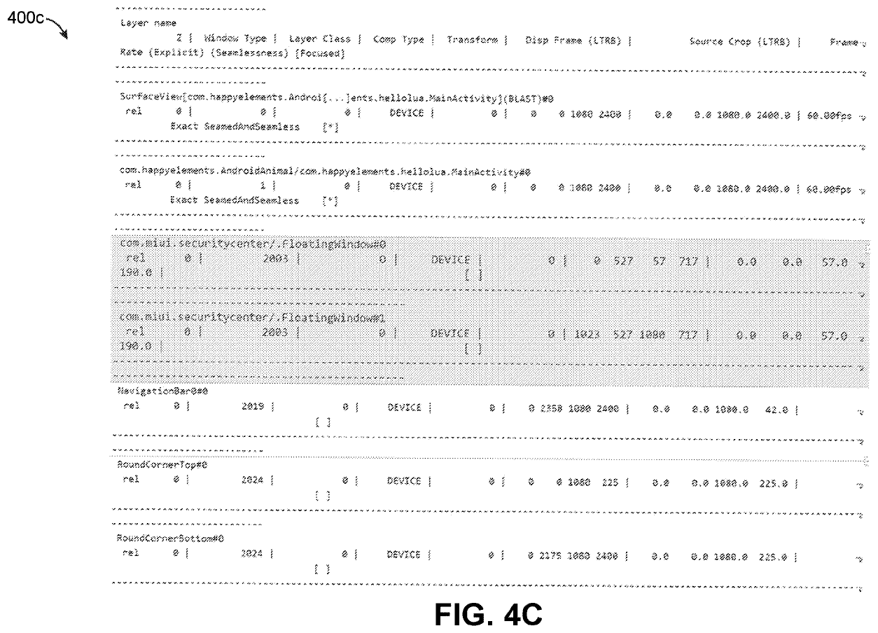

For example, FIG. 4A is a diagram 400 illustrating an example of frame layers that may be associated with a frame of captured video display data. In one illustrative example, a frame of captured video display data 410 can be captured by or otherwise obtained from a smartphone or other mobile computing device that acts as a source device for wireless display sharing (e.g., WiFi display sharing, Miracast®, etc.). The frame of captured video display data 410 can be associated with layer information that includes at least a layer index 420 and a layer type 430. For example, each frame of captured video display data (e.g., such as the frame of captured video display data 410) can include one or more layers, wherein individual layers are associated with different icons, applications, UI elements, etc., that are displayed in the frame of captured video display data 410.

For example, a first layer can be associated with a background displayed in or included in the frame of captured video display data 410; a second layer can be associated with a status bar system user interface (UI) element (e.g., displaying system information such as the current time, notifications, connected network(s), notifications, battery percentage, etc.); a third layer can be associated with application icons that are rendered on top of the background display layer; a fourth layer can be associated with a picture-in-picture (PIP) or floating window UI element that displays a mobile app on top of the other layers; etc.

In some examples, the systems and techniques can utilize frames of captured video display data that are Miracast® frames or other frames associated with wireless display sharing. In some aspects, a Miracast® frame can include or be associated with layer information for each layer that is included in a given frame. In some aspects, each frame of captured video display data (e.g., such as the frame of captured video display data 410) can include one or more layers. For example, frame 410 can include between one and 15 layers that are composed into the final rendered view of frame 410 that is captured and shared as a Miracast® or other wireless display sharing frame.

For example, the frames of captured video display data can be generated or otherwise obtained by a source device (e.g., a smartphone) that performs wireless display sharing. The layer information of each respective frame can be determined by (e.g., populated by) the source device during the wireless display sharing process. For example, the source device can generate Miracast® frames or other frames of captured video display data for wireless display sharing that include the geometry of the individual layers included in each respective frame, the coordinates of each layer, the format or layer type of each layer, etc.

For example, as illustrated in FIG. 4A, the frame of captured video display data 410 can include layers with indices 0, 1, 6, 7, and 8 and a layer type (e.g., the Comp Type 430) of “SDE” (e.g., Snapdragon Display Engine, or other hardware display process unit(s)). For example a layer type or Comp type “SDE” can indicate that the corresponding layer will be composed by an SDE or other hardware display process unit(s). Frame 410 can additionally include a layer with index 11 and a layer type (e.g., the Comp Type 430) of “GPU_TARGET”. In some aspects, layer information such as the layer index 420 and the layer comp type 430 can be provided by the source device associated with the frame of captured video display data 410.

FIG. 4B is a diagram illustrating an example layer stack 450 associated with a frame of captured video display data, in accordance with some examples. For example, the layer stack 450 can be an application layer stack, wherein applications running on (e.g., currently rendered on the display of) a smartphone or other mobile computing device are each associated with one or more layers in the layer stack 450.

The layer stack 450 can include a plurality of different layers that are sorted (e.g., “stacked”) in z-order, with the layer on the top of the stack 450 being the topmost layer that is visible when the layer stack 450 is rendered on a display of a smartphone or other computing device. For example, the layer associated with ‘App 4’ can be the topmost layer that is visible in the frame of captured video display data associated with the example layer stack 450, while the layer associated with ‘App 0’ can be the bottommost layer (e.g., of the layers included in layer stack 450) that is rendered beneath the remaining layers of layer stack 450.

As mentioned previously, each frame of captured video display data can include a plurality of layers (e.g., also referred to as “sub-layers”). In some aspects, the quantity and/or type of layers between successive frames of captured video display data can change. Each layer may be associated with layer information and/or layer parameters. For example, each layer can be associated with a layer name, a z-order, a format, a layer class, one or more transforms, one or more flags, metadata, frame region coordinates, etc. In one illustrative example, the layer information utilized by the systems and techniques described herein can be the same as or similar to information utilized by a source device (e.g., a source device participating in wireless display sharing) to determine frame composition, geometry rendering, tone mapping, and/or various other display post-processing operations.

In some aspects, the layer information may determine the geometry of the resulting frame. For example, the geometry of a frame that includes five layers can be determined based on the layer information associated with each respective layer of the five layers. Based on the layer information determining the resulting frame geometry, the layer information may also determine the final content pixels that are rendered in (or otherwise visible in) the final frame that is generated based on the layer information.

A layer name can be specified by an application (e.g., running on the source device) and/or an operating system (OS) framework (e.g., the OS framework of the source device). In some aspects, the layer name may also be referred to as a layer readable ID or a layer identifier. Based on the layer name parameter being specified at least in part by an application running on the source device, layers associated with different applications may have different names and naming conventions. In one illustrative example, the layer name associated with a given layer can be used to determine a usage or use case associated with a given layer, one or more content classifications associated with the given layer, and/or application information associated with the given layer. For example, the systems and techniques can use the layer name parameter to determine whether a given layer is a game layer or a non-game layer (e.g., because a game layer may be associated with rapidly changing content and may benefit from a shorter GOP length than a non-game layer).

Layer information may also include a z-order for some (or all) of the layers associated with a given frame of captured video display data. The z-order of a layer can indicate the relative positioning of the layer (e.g., with respect to other layers of the same frame) along the z-axis. For example, the z-axis ordering of layers can be used to determine which layers are on top of other layers, which layers are beneath other layers, etc.

Layer information associated with a given frame can include a frame layer number or a frame layer quantity parameter, indicating the quantity of layers that are included in the given frame of captured video display data. For example, the frame layer number information can indicate that a given frame of captured video display data includes a total of eight layers. In some aspects, the frame layer number information can additionally identify subsets of layers that are associated with specific applications or sources. For example, the frame layer number information can indicate that a given frame of captured video display data includes a total of eight layers, with four of the layers being associated with a first application, two of the layers being associated with a second application, and two of the layers being associated with the source device OS.

In some aspects, layer information can include transform information. For example, transform information can be indicative of one or transforms that are applied to the layer content. In some aspects, the layer transform information can be indicative of how a given layer is rotated or flipped (e.g., if at all). For example, the layer transform information can indicate that a layer undergoes no transformation, is rotated 90 degrees clockwise, is rotated 90 degrees counterclockwise, etc.

In some aspects, layer information can include display frame information. For example, display frame information can be indicative of where a given layer is located within its associated frame (e.g., the frame of captured video display data that includes the given layer). In one illustrative example, the display frame information can include two-dimensional (2D) coordinates indicative of the positioning of a given layer within its associated frame and the extent (e.g., size) of the given layer within its associated frame. For example, the display frame information can include (x, y) coordinates indicating the position of one or more corners of a given layer included in a frame.

In some aspects, layer information can include metadata information. For example, the metadata information can be information associated with rendering some (or all) of the visual content or pixels of a given layer. In one illustrative example, the metadata information can include one or more of layer color(s), layer brightness, high-dynamic range (HDR) information, electro-optical transfer function (EOTF) information, and/or opto-electronic transfer function (OETF) information, etc.

In some aspects, layer information can include a composition type (e.g., also referred to as “comp type”). The composition type can indicate whether a given layer will be composed by a data processing unit (DPU), a graphics processing unit (GPU), or other hardware processors.

In some aspects, layer information can include one or more flags indicative of specific processing needed for a given layer. For example, a layer may be associated with a flag indicating that the layer requires secure processing, external display only processing, etc.

In some aspects, layer information can include a layer format. Layer formats can include RGB or YUV, RGB1010102 or FP16, etc.

In some examples, layer information can be obtained for each layer included in a given frame of captured video display data. In one illustrative example, layer information for the layers included in a given frame can be obtained in a combined listing of layer information. For example, FIG. 4C depicts an example table 400c that includes an example listing of layer information that may be obtained for a frame of captured video display data.

In some aspects, conventional video streams (e.g., captured by a camera or a camera included in a smartphone or other mobile device) may not include any layer information as such video streams are captured as a single layer recording. In one illustrative example, the systems and techniques described herein can use layer information that is included in or otherwise associated with frames of captured video display data to determine scene information for setting an adaptive or variable length GOP (e.g., an adaptive or variable I-frame time interval). In some cases, the layer information can be associated with the frames of captured video display data based on the layer information being used to originally render the video display data on a display of a source device that is participating in wireless display sharing. In some examples, the layer information associated with frames of captured video display data can include rich scene information that can be analyzed more efficiently than a pixel-based content or motion analysis. Based on the rich scene information determined from the layer information, the systems and techniques can implement scene change analysis, notifications, and/or I-frame triggering, as will be described in greater depth below.

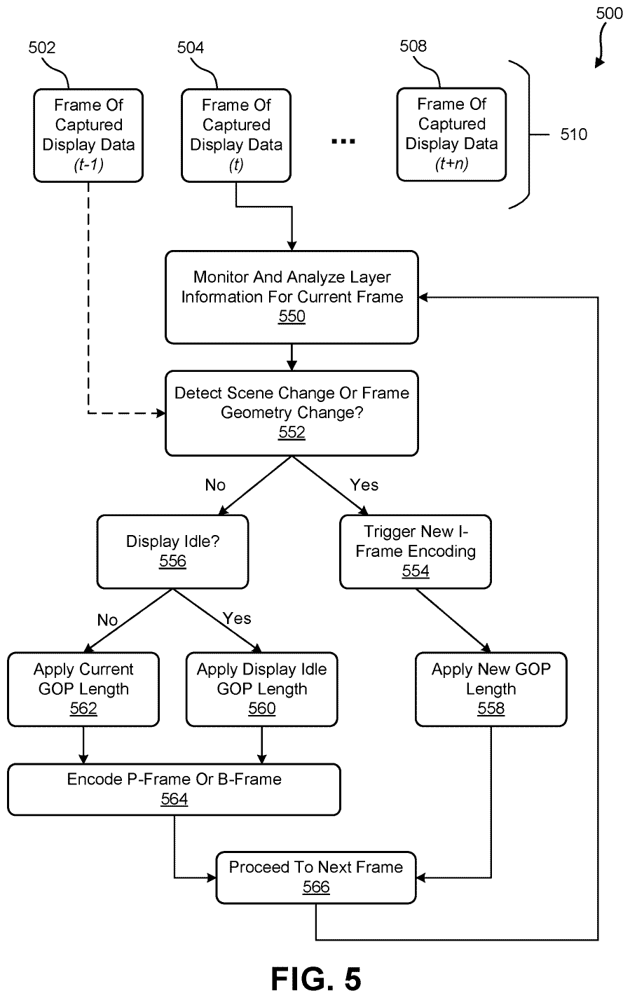

FIG. 5 is a flow chart illustrating an example of a process 500 that may be implemented by the systems and techniques described herein to perform video coding using a variable length GOP (e.g., variable I-frame time interval) that is adaptively determined based on layer information associated with one or more frames of video display data.

In one illustrative example, the one or more frames of video display data may be frames of captured video display data obtained from a source device participating in wireless display sharing (e.g., such as Miracast®). For example, a plurality of frames of captured video display data 510 can include a current frame 504 (e.g., associated with a time t), a previous frame 502 (e.g., associated with a time t−1), and n additional frames up to a final frame associated with a time t+n.

The plurality of frames of captured video display data 510 can be encoded with a variable GOP length and a variable I-frame time interval based on monitoring and analyzing the layer information for some (or all) of the respective frames included in the plurality of frames 510. For example, at block 550, the systems and techniques can monitor and analyze layer information obtained for or otherwise associated with a current frame 504 (e.g., the frame associated with the current time t) In some aspects, monitoring and analyzing the layer information for current frame 504 at block 550 can include obtaining the layer information for current frame 504 prior to performing the analysis.

At block 552, the systems and techniques can compare the current frame 504 to one or more previous frames (e.g., such as the previous frame 502 associated with time t−1) to determine whether a scene change has occurred and/or to determine whether a frame geometry change has occurred. For example, layer information associated with the previous frame 502 can be compared to layer information associated with the current frame 504 (e.g., the layer information determined and analyzed at block 550). In some aspects, the layer information associated with the previous frame 502 can be stored in a previous time step in which frame 502 was the current frame provided to block 550 for analysis.

In one illustrative example, a scene change or a frame geometry change can be detected at block 552 based on one or more parameters included in the layer information of the previous frame 502 and/or included in the layer information of the current frame 504 changing by an amount that is greater than a pre-determined threshold. For example, a scene or frame geometry change can be detected at block 552 based on the number of layers changing (e.g., increasing from four layers in frame 502 to six layers in frame 504) and/or based on one or more layer size changes (e.g., a layer increases in size by at least 25% from frame 502 to frame 504). In some cases, a scene or frame geometry change can be detected at block 552 based on one or more layer position changes (e.g., moving up/down, left/right by an amount greater than 50% the corresponding dimension of the layer), and/or based on one or more layer format changes (e.g., changing from HDR YUV 10-bit in frame 502 to SDR YUV 8-bit in frame 504).

In some aspects, a scene change or frame geometry change can additionally, or alternatively, be detected at block 552 based on identifying a change in a primary layer from previous frame 502 to current frame 504. For example, a primary layer of a given frame of captured video display data 510 can be the highest positioned layer (e.g., in the z-order of layer stack 450 illustrated in FIG. 4B) of a sufficiently large size. In some cases, the primary layer of a given frame can be the highest positioned layer (e.g., that is at the top or near the top of the given frame) that exceeds a pre-determined size threshold. For example, the pre-determined size threshold can be 30% of the pixel area of the given frame.

Based on detecting a scene change or a frame geometry change at block 552 (e.g., the “Yes” option illustrated in FIG. 5), the systems and techniques can automatically trigger I-frame encoding at block 554. For example, a new I-frame can be encoded based on the current frame 504 and used as a key frame for the encoded video data generated for the plurality of frames of captured video display data 510.

A new GOP length can additionally be determined and applied at block 558 (e.g., in combination with the new I-frame encoding triggered at block 554 in response to detecting a significant scene change or frame geometry change at block 552). For example, the new GOP length can indicate the number of frames (e.g., of the plurality of frames of captured video display data 510) that will be encoded as B-frames or P-frames before another I-frame key frame is to be encoded. In one illustrative example, the new GOP length determined and applied at block 558 can be based on a GOP length determined for a primary layer identified for the currently encoded frame 504. As mentioned previously, a primary layer of a given frame of captured video display data 510 can be the highest positioned layer (e.g., in the z-order of layer stack 450 illustrated in FIG. 4B) of a sufficiently large size. In some aspects, the GOP length can be based on a type of the primary layer and/or can be based on layer information associated with the primary layer.

For example, a GOP length can be determined based on one or more of a layer name, a layer format, layer metadata, and/or a layer size that are associated with the identified primary layer for the currently encoded frame of captured video display data (e.g., current frame 504). In some aspects, the mapping of GOP length values to layer information combinations can be pre-determined. In some examples, a machine learning (ML) network or classifier can be trained to generate GOP length values based on layer information associated with a primary layer. For example, a neural network or a deep neural network (DNN) can be trained as a classifier over layer information such as layer name, layer format, layer metadata, layer size, etc. In some examples, a neural network classifier can be trained to output a GOP length value based on receiving as input the layer information for a primary layer. In some examples, a neural network classifier can be trained to output a semantic classification, indicative of a primary layer type, based on receiving as input the layer information for the primary layer (e.g., and the semantic classification can subsequently be mapped to a pre-determined GOP length value for the respective semantic classification).

Different GOP lengths can be determined or utilized for different types of primary layers, based at least in part on a content type of the primary layer and/or an expected frequency of frame geometry changes for the content type of the primary layer. For example, a primary layer that is a game layer may be associated with a relatively short GOP length (e.g., 60 frames), while a primary layer that is an email client/application layer may be associated with a relatively longer GOP length (e.g., 120 frames). In some examples, a video playback layer and/or a YUV color format layer can be associated with a GOP length that is shorter than the game layer GOP length (e.g., the video playback layer and/or YUV color format layer may be associated with a GOP length of 30 frames). In some aspects, a primary layer that includes relatively static content, such as content from a text-based chat or messaging application, can have a relatively long GOP length (e.g., 300 frames). Similarly, a primary layer that includes relatively static content, such as content from a slideshow presentation application, can also have a relatively long GOP length (e.g., 300 frames).

After triggering a new I-frame (e.g., key frame) encoding at block 554 for the currently encoded frame 504 and applying a new GOP length (e.g., at block 558) based on the layer information or layer type of the primary layer of the currently encoded frame 504, the systems and techniques can proceed to the next frame at block 566. For example, after encoding the current frame 504 (e.g., associated with time ( ) the systems and techniques can proceed from block 566 to analyzing the layer information of the next frame (e.g., associated with time (+1) by returning to block 550.

Returning to the discussion of encoding the current frame 504, if a scene change or frame geometry change is not detected at block 552 (e.g., the “No” option), the systems and techniques can proceed to block 556, which determines whether a display idle state has occurred or is occurring. For example, at block 556, the systems and techniques can determine that the video content represented in the frames of captured display data from the source device has transitioned to an idle state. In some aspects, the idle state can be associated with detecting no content change over a pre-determined period of time and/or detecting no additional rendering or refreshing of the frames of captured display data. For example, a display idle state can be detected or triggered at block 556 based on no scene or frame geometry change being detected at block 552 for a pre-determined number of consecutive frames.

In some examples, detecting or determining a display idle state can cause the systems and techniques to apply a new, relatively long GOP length that is associated with the display idle state (e.g., also referred to as a “display idle GOP length”). For example, the display idle GOP length can be 300 frames, although a greater or lesser number of frames may also be utilized for the display idle GOP length. For example, if a display idle state is detected at block 556 (e.g., the “Yes” option), the systems and techniques can apply the display idle GOP length at block 560. If a display idle state is not detected at block 556 (e.g., the “No” option), the systems and techniques can apply (e.g., maintain) the current GOP length at block 562. In one illustrative example, the current GOP length that may be applied or maintained at block 562 (e.g., when no display idle is detected) can be the same as the most recently applied new GOP length associated with the most recent I-frame (e.g., the most recently applied new GOP length from the last time that block 558 was reached).

After applying the display idle GOP length at block 560 or maintaining the current GOP length at block 562, the systems and techniques can encode the currently encoded frame 504 as either a P-frame or a B-frame (e.g., a non-I-frame, as the current frame 504 would be encoded as an I-frame only when block 554 is reached, based on detecting a scene or frame geometry change at block 552). After encoding the currently encoded frame 504 as a P-frame or a B-frame at block 564, the systems and techniques can proceed to the next frame (e.g., the frame associated with time t+1) based on block 566 returning the process 500 to block 550.

In one illustrative example, if the previous (e.g., associated with time t−1) frame 502 includes four layers and the current (e.g., associated with time t) frame 504 includes six layers, a scene change and/or frame geometry change can be detected at block 552, a new I-frame encoding can be triggered at block 554, and a new GOP length can be applied at block 558 (e.g., wherein the new GOP length is based on a GOP length associated with a primary layer of the currently encoded frame 504).

In another illustrative example, if the previous frame 502 includes a layer with layer size information given by 0 0 1080 2400 and the current frame 504 includes the same layer with layer size information now given by 220 180 540 1200, a frame geometry change can be detected at block 552, a new I-frame encoding can be triggered at block 554, and a new GOP length can be applied at block 558.

In another illustrative example, if previous frame 502 includes a layer with metadata information and/or format information indicating that the layer is an HDR YUV 10-bit format and the current frame 504 includes the same layer with metadata and/or format information now indicating that the layer is an SDR YUV 8-bit layer, a scene change and/or frame geometry change can be detected at block 552, a new I-frame encoding can be triggered at block 554, and a new GOP length can be applied at block 558.

In another example, if a layer name changes between previous frame 502 and current frame 504, a scene change can be detected at block 552. For example, the scene change can be detected based on determining that the layer name from previous frame 502 is not included in current frame 504. In some aspects, a layer name that is present in previous frame 502 but not in current frame 504 can indicate that one or more new layers are included in current frame 504. In some cases, a layer name that is present in previous frame 502 but not in current frame 504 can indicate that a new primary layer will be active for or included in current frame 504. In either case, a scene change can be detected at block 552, a new I-frame encoding can be triggered at block 554, and a new GOP length can be applied at block 558.

In some aspects, the plurality of frames of captured video display data 510 can be sequential frames that are captured or obtained and subsequently encoded in real-time. In some aspects, the plurality of frames of captured video display data 510 can include a plurality of frames associated with a wireless display sharing (e.g., Miracast) session, in which a source device (e.g., smartphone or other computing device) mirrors its display contents to a target device (e.g., a television). For example, the frame 502 can be a first frame captured for a wireless display sharing session and the frame 508 can represent the last frame captured for the same wireless display sharing session.

As mentioned previously, the GOP length and I-frame interval used to code the plurality of frames of captured video display data 510 can change over time. For example, if the frame 502 includes eight layers and the frame 504 includes four layers, a scene change is detected at block 552, triggering a new I-frame (e.g., key frame) encoding at block 554 and the application of a new GOP length (e.g., specific to the primary layer of frame 504) at block 558. If the primary layer of the currently encoded frame 504 is a YUV format layer with a 4K resolution, the new GOP length applied at block 558 can be a target GOP length associated with YUV 4K layers. For example, if YUV 4K layers are associated with a target GOP length of 30 frames, then the new target GOP length applied at block 558 can be 30 frames.

If subsequently, no scene changes or frame geometry changes are detected in excess of a pre-determined threshold for one minute (e.g., the determination at block 552 is “No” for one minute worth of frames 510 that are after frame 504), then the target GOP length will remain at 30 frames and a new I-frame is triggered every 30 frames. If the frames 510 are associated with a playback speed of 30 fps, then a new I-frame is triggered once per second, for a total of 60 I-frames triggered over the one-minute period wherein no scene changes or frame geometry changes are detected at block 552.

If, at the one-minute mark, the currently encoded frame layer number increases from four to six, then a scene change is detected at block 552, a new I-frame is immediately triggered at block 554 (e.g., independent of whether the target GOP length of 30 frames has been met yet), and a new target GOP length is applied at block 558.

If no further scene changes or frame geometry changes are detected at block 552 for the next 20 minutes, then I-frame triggering will proceed for the 20-minute period based on the current target GOP length. Initially, the target GOP length may be the GOP length determined at block 558 when the frame layer count increased from four to six. After a pre-determined number of consecutive frames are analyzed at block 552 without detected a scene change or frame geometry change, then the target GOP length is updated to the display idle GOP length (e.g., at block 560). For example, the display idle GOP length can be a relatively long GOP length (e.g., such as 300 frames or 10 seconds, for 30 fps video).

If, at the 20-minute mark, the frame layer number remains unchanged (e.g., remains at six layers) but one or more of the layer sizes and/or the layer coordinates changes, then a scene change will be detected at block 552 and a new I-frame encoding will be triggered immediately at block 554 (e.g., even if the display idle GOP length has not yet been reached). A new GOP length can subsequently be determined based on the primary layer of the frame associated with the layer size changes and/or the layer coordinate change and can be applied at block 558 to replace the display idle GOP length.

In one illustrative example, the systems and techniques described herein can be used to perform real-time or “online” video coding. For example, in the context of wireless display sharing (e.g., Miracast) from a source device to a target device, frames of captured video display data are obtained at the source device, encoded, and transmitted for mirrored display on the target device in substantially real-time. Based on detecting scene changes and/or frame geometry changes without performing content analysis or motion analysis that is based on analyzing pixel-level information, the systems and techniques can utilize variable GOP lengths and/or I-frame intervals to more efficiently provide real-time video encoding and decoding.

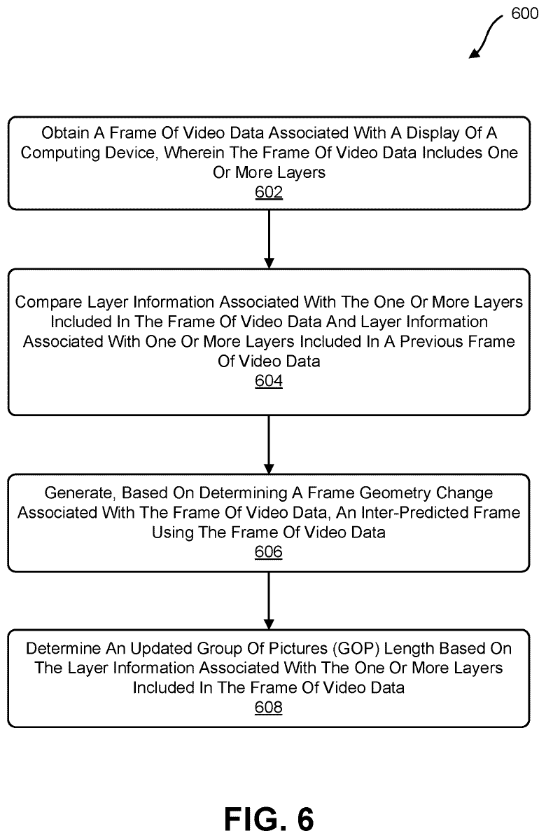

FIG. 6 is a flowchart illustrating an example of a process 600 for encoding or decoding (coding) video data according to aspects described herein. At block 602, the process 600 includes obtaining a frame of video data associated with a display of a computing device, wherein the frame of video data includes one or more layers. For example, the frame of video data can be obtained from video source 102 associated with a display of encoding device 104, illustrated in FIG. 1. In some examples, the frame of video data can be the same as or similar to the frame 410 illustrated in FIG. 4A, which includes the one or more layers 450 illustrated in FIG. 4B. In some cases, the frame of video data can be the same as or similar to one or more of the frames 510 illustrated in FIG. 5 (e.g., one or more of frame 502, 504, 508, etc.).

In some cases, the frame of video data includes video display data displayed on a display of the computing device. In some examples, the frame of video data can be a frame of captured video display data associated with wireless display sharing (e.g., Miracast) from the computing device to a second computing device. For example, the frame of video data can be a frame of captured video display data associated with wireless display sharing from the encoding device 104 illustrated in FIG. 1 to the decoding device 112 illustrated in FIG. 1.

At block 604, the process 600 includes comparing layer information associated with the one or more layers included in the frame of video data and layer information associated with one or more layers included in a previous frame of video data. For example, the layer information can include at least the layer index value 420 and the comp type 430 information illustrated in FIG. 4A. In some cases, the layer information can be associated with the one or more layers included in the frame of video data, such as the one or more layers included in the app layer stack 450 illustrated in FIG. 4B. In some cases, the layer information can include some (or all) of the layer information illustrated in the table 400c depicted in FIG. 4C.

In some cases, the layer information can include, for each respective layer included in the one or more layers, at least one of a layer name associated with each respective layer, a layer format associated with each respective layer, and one or more coordinates associated with each respective layer. In some examples, the layer information can include at least one of a quantity of layers or a frame layer number (e.g., such as the layer index value 420 illustrated in FIG. 4A). In some cases, the frame of video data and the previous frame of video data can be sequential frames of captured video display data. For example, the frame of video data can be the same as or similar to the frame of captured display data 504 illustrated in FIG. 5 and the previous frame of video data can be the same as or similar to the frame of captured display data 502 illustrated in FIG. 5. In

In some examples, the frame of video data and the previous frame of video data can be sequential frames included in a plurality of frames of captured video display data (e.g., such as the plurality of frames 510 illustrated in FIG. 5). In some examples, at least a portion of the plurality of frames of captured video display data can be encoded using an inter-predicted frame, as described in greater depth below. In some cases, encoded video data can be transmitted to a second device associated with a same wireless display sharing session as the computing device. The encoded video can include the inter-predicted frame and at least one of a uni-predicted frame or a bi-predicted frame generated based on encoding at least the portion of the plurality of frames of captured video display data.

At block 606, the process 600 includes generating, based on determining a frame geometry change associated with the frame of video data, an inter-predicted frame using the frame of video data. For example, determining the frame geometry change associated with the frame of video data can be based on comparing the layer information associated with the one or more layers included in the frame of video data and the layer information associated with the one or more layers included in the previous frame of video data. In some cases, the frame geometry change can be determined based on determining that the layer information associated with the one or more layers included in the frame of video data have changed by greater than a threshold amount compared to the layer information associated with the one or more layers included in the previous frame of video data.

At block 608, the process 600 includes determining an updated group of pictures (GOP) length based on the layer information associated with the one or more layers included in the frame of video data. For example, the updated GOP length can be determined based on layer information associated with a primary layer included in the frame of video data. In some cases, the primary layer included in the frame of video data can be rendered using a z-order that is greater than a respective z-order associated with one or more additional layers included in the frame of video data.

In some examples, the process 600 can include determining that a frame geometry change is not associated with the frame of video data, based on the layer information associated with the one or more layers included in the frame of video data changing by less than a threshold amount compared to the layer information associated with the one or more layers included in the previous frame of video data. In some cases, a display idle state associated with the frame of video data can be detected, based on the frame of video data and a pre-determined quantity of previous frames of video data not being associated with a frame geometry change. In some examples, a display idle GOP length can be applied, wherein the display idle GOP length is greater than the updated GOP length. In some cases, the frame of video data can be encoded as a predicted frame (P-frame) or a bidirectional frame (B-frame) based on the frame of video data not being associated with a frame geometry change.

In some cases, the process 600 can be performed by a decoding device (e.g., the decoding device 112 of FIG. 1 and FIG. 8). In some cases, the process 600 can be performed by an encoding device (e.g., the encoding device 104 of FIG. 1 and FIG. 7). For instance, the process 600 can include generating an encoded video bitstream including information associated with the block of video data. In some examples, the process 600 can include storing the encoded video bitstream (e.g., in the at least one memory of the apparatus). In some examples, the process 600 can include transmitting the encoded video bitstream (e.g., using a transmitter of the apparatus).

In some implementations, the processes (or methods) described herein can be performed by a computing device or an apparatus, such as the system 100 shown in FIG. 1. For example, the processes can be performed by the encoding device 104 shown in FIG. 1 and FIG. 7, by another video source-side device or video transmission device, by the decoding device 112 shown in FIG. 1 and FIG. 8, and/or by another client-side device, such as a player device, a display, or any other client-side device. In some cases, the computing device or apparatus may include a processor, microprocessor, microcomputer, or other component of a device that is configured to carry out the steps of the processes described herein. In some examples, the computing device or apparatus may include a camera configured to capture video data (e.g., a video sequence) including video frames. In some examples, a camera or other capture device that captures the video data is separate from the computing device, in which case the computing device receives or obtains the captured video data. The computing device may further include a network interface configured to communicate the video data. The network interface may be configured to communicate Internet Protocol (IP) based data or other type of data. In some examples, the computing device or apparatus may include a display for displaying output video content, such as samples of pictures of a video bitstream.

The processes can be described with respect to logical flow diagrams, the operation of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

The coding techniques discussed herein may be implemented in an example video encoding and decoding system (e.g., system 100). In some examples, a system includes a source device that provides encoded video data to be decoded at a later time by a destination device. In particular, the source device provides the video data to destination device via a computer-readable medium. The source device and the destination device may comprise any of a wide range of devices, including desktop computers, notebook (e.g., laptop) computers, tablet computers, set-top boxes, telephone handsets such as so-called “smart” phones, so-called “smart” pads, televisions, cameras, display devices, digital media players, video gaming consoles, video streaming device, or the like. In some cases, the source device and the destination device may be equipped for wireless communication.

The destination device may receive the encoded video data to be decoded via the computer-readable medium. The computer-readable medium may comprise any type of medium or device capable of moving the encoded video data from source device to destination device. In one example, computer-readable medium may comprise a communication medium to enable source device to transmit encoded video data directly to destination device in real-time. The encoded video data may be modulated according to a communication standard, such as a wireless communication protocol, and transmitted to destination device. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device to destination device.

In some examples, encoded data may be output from output interface to a storage device. Similarly, encoded data may be accessed from the storage device by input interface. The storage device may include any of a variety of distributed or locally accessed data storage media such as a hard drive, Blu-ray discs, DVDs, CD-ROMs, flash memory, volatile or non-volatile memory, or any other suitable digital storage media for storing encoded video data. In a further example, the storage device may correspond to a file server or another intermediate storage device that may store the encoded video generated by source device. Destination device may access stored video data from the storage device via streaming or download. The file server may be any type of server capable of storing encoded video data and transmitting that encoded video data to the destination device. Example file servers include a web server (e.g., for a website), an FTP server, network attached storage (NAS) devices, or a local disk drive. Destination device may access the encoded video data through any standard data connection, including an Internet connection. This may include a wireless channel (e.g., a Wi-Fi connection), a wired connection (e.g., DSL, cable modem, etc.), or a combination of both that is suitable for accessing encoded video data stored on a file server. The transmission of encoded video data from the storage device may be a streaming transmission, a download transmission, or a combination thereof.

The techniques of this disclosure are not necessarily limited to wireless applications or settings. The techniques may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications. In some examples, system may be configured to support one-way or two-way video transmission to support applications such as video streaming, video playback, video broadcasting, and/or video telephony.

In one example the source device includes a video source, a video encoder, and an output interface. The destination device may include an input interface, a video decoder, and a display device. The video encoder of source device may be configured to apply the techniques disclosed herein. In other examples, a source device and a destination device may include other components or arrangements. For example, the source device may receive video data from an external video source, such as an external camera. Likewise, the destination device may interface with an external display device, rather than including an integrated display device.

The example system above is merely one example. Techniques for processing video data in parallel may be performed by any digital video encoding and/or decoding device. Although generally the techniques of this disclosure are performed by a video encoding device, the techniques may also be performed by a video encoder/decoder, typically referred to as a “CODEC.” Moreover, the techniques of this disclosure may also be performed by a video preprocessor. Source device and destination device are merely examples of such coding devices in which source device generates coded video data for transmission to destination device. In some examples, the source and destination devices may operate in a substantially symmetrical manner such that each of the devices include video encoding and decoding components. Hence, example systems may support one-way or two-way video transmission between video devices, e.g., for video streaming, video playback, video broadcasting, or video telephony.

The video source may include a video capture device, such as a video camera, a video archive containing previously captured video, and/or a video feed interface to receive video from a video content provider. As a further alternative, the video source may generate computer graphics-based data as the source video, or a combination of live video, archived video, and computer-generated video. In some cases, if video source is a video camera, source device and destination device may form so-called camera phones or video phones. As mentioned above, however, the techniques described in this disclosure may be applicable to video coding in general, and may be applied to wireless and/or wired applications. In each case, the captured, pre-captured, or computer-generated video may be encoded by the video encoder. The encoded video information may then be output by output interface onto the computer-readable medium.

As noted above, the computer-readable medium may include transient media, such as a wireless broadcast or wired network transmission, or storage media (that is, non-transitory storage media), such as a hard disk, flash drive, compact disc, digital video disc, Blu-ray disc, or other computer-readable media. In some examples, a network server (not shown) may receive encoded video data from the source device and provide the encoded video data to the destination device, e.g., via network transmission. Similarly, a computing device of a medium production facility, such as a disc stamping facility, may receive encoded video data from the source device and produce a disc containing the encoded video data. Therefore, the computer-readable medium may be understood to include one or more computer-readable media of various forms, in various examples.

The input interface of the destination device receives information from the computer-readable medium. The information of the computer-readable medium may include syntax information defined by the video encoder, which is also used by the video decoder, that includes syntax elements that describe characteristics and/or processing of blocks and other coded units, e.g., group of pictures (GOP). A display device displays the decoded video data to a user, and may comprise any of a variety of display devices such as a cathode ray tube (CRT), a liquid crystal display (LCD), a plasma display, an organic light emitting diode (OLED) display, or another type of display device. Various examples of the application have been described.

Specific details of the encoding device 104 and the decoding device 112 are shown in FIG. 7 and FIG. 8, respectively. FIG. 7 is a block diagram illustrating an example encoding device 104 that may implement one or more of the techniques described in this disclosure. Encoding device 104 may, for example, generate the syntax structures described herein (e.g., the syntax structures of a VPS, SPS, PPS, or other syntax elements). Encoding device 104 may perform intra-prediction and inter-prediction coding of video blocks within video slices. As previously described, intra-coding relies, at least in part, on spatial prediction to reduce or remove spatial redundancy within a given video frame or picture. Inter-coding relies, at least in part, on temporal prediction to reduce or remove temporal redundancy within adjacent or surrounding frames of a video sequence. Intra-mode (I mode) may refer to any of several spatial based compression modes. Inter-modes, such as uni-directional prediction (P mode) or bi-prediction (B mode), may refer to any of several temporal-based compression modes.

The encoding device 104 includes a partitioning unit 35, prediction processing unit 41, filter unit 63, picture memory 64, summer 50, transform processing unit 52, quantization unit 54, and entropy encoding unit 56. Prediction processing unit 41 includes motion estimation unit 42, motion compensation unit 44, and intra-prediction processing unit 46. For video block reconstruction, encoding device 104 also includes inverse quantization unit 58, inverse transform processing unit 60, and summer 62. Filter unit 63 is intended to represent one or more loop filters such as a deblocking filter, an adaptive loop filter (ALF), and a sample adaptive offset (SAO) filter. Although filter unit 63 is shown in FIG. 8 as being an in-loop filter, in other configurations, filter unit 63 may be implemented as a post loop filter. A post processing device 57 may perform additional processing on encoded video data generated by the encoding device 104. The techniques of this disclosure may in some instances be implemented by the encoding device 104. In other instances, however, one or more of the techniques of this disclosure may be implemented by post processing device 57.

As shown in FIG. 7, the encoding device 104 receives video data, and partitioning unit 35 partitions the data into video blocks. The partitioning may also include partitioning into slices, slice segments, tiles, or other larger units, as wells as video block partitioning, e.g., according to a quadtree structure of LCUs and CUs. The encoding device 104 generally illustrates the components that encode video blocks within a video slice to be encoded. The slice may be divided into multiple video blocks (and possibly into sets of video blocks referred to as tiles). Prediction processing unit 41 may select one of a plurality of possible coding modes, such as one of a plurality of intra-prediction coding modes or one of a plurality of inter-prediction coding modes, for the current video block based on error results (e.g., coding rate and the level of distortion, or the like). Prediction processing unit 41 may provide the resulting intra- or inter-coded block to summer 50 to generate residual block data and to summer 62 to reconstruct the encoded block for use as a reference picture.

Intra-prediction processing unit 46 within prediction processing unit 41 may perform intra-prediction coding of the current video block relative to one or more neighboring blocks in the same frame or slice as the current block to be coded to provide spatial compression. Motion estimation unit 42 and motion compensation unit 44 within prediction processing unit 41 perform inter-predictive coding of the current video block relative to one or more predictive blocks in one or more reference pictures to provide temporal compression.

Motion estimation unit 42 may be configured to determine the inter-prediction mode for a video slice according to a predetermined pattern for a video sequence. The predetermined pattern may designate video slices in the sequence as P slices, B slices, or GPB slices. Motion estimation unit 42 and motion compensation unit 44 may be highly integrated, but are illustrated separately for conceptual purposes. Motion estimation, performed by motion estimation unit 42, is the process of generating motion vectors, which estimate motion for video blocks. A motion vector, for example, may indicate the displacement of a prediction unit (PU) of a video block within a current video frame or picture relative to a predictive block within a reference picture.

A predictive block is a block that is found to closely match the PU of the video block to be coded in terms of pixel difference, which may be determined by sum of absolute difference (SAD), sum of square difference (SSD), or other difference metrics. In some examples, the encoding device 104 may calculate values for sub-integer pixel positions of reference pictures stored in picture memory 64. For example, the encoding device 104 may interpolate values of one-quarter pixel positions, one-eighth pixel positions, or other fractional pixel positions of the reference picture. Therefore, motion estimation unit 42 may perform a motion search relative to the full pixel positions and fractional pixel positions and output a motion vector with fractional pixel precision.

Motion estimation unit 42 calculates a motion vector for a PU of a video block in an inter-coded slice by comparing the position of the PU to the position of a predictive block of a reference picture. The reference picture may be selected from a first reference picture list (List 0) or a second reference picture list (List 1), each of which identify one or more reference pictures stored in picture memory 64. Motion estimation unit 42 sends the calculated motion vector to entropy encoding unit 56 and motion compensation unit 44.

Motion compensation, performed by motion compensation unit 44, may involve fetching or generating the predictive block based on the motion vector determined by motion estimation, possibly performing interpolations to sub-pixel precision. Upon receiving the motion vector for the PU of the current video block, motion compensation unit 44 may locate the predictive block to which the motion vector points in a reference picture list. The encoding device 104 forms a residual video block by subtracting pixel values of the predictive block from the pixel values of the current video block being coded, forming pixel difference values. The pixel difference values form residual data for the block, and may include both luma and chroma difference components. Summer 50 represents the component or components that perform this subtraction operation. Motion compensation unit 44 may also generate syntax elements associated with the video blocks and the video slice for use by the decoding device 112 in decoding the video blocks of the video slice.

Intra-prediction processing unit 46 may intra-predict a current block, as an alternative to the inter-prediction performed by motion estimation unit 42 and motion compensation unit 44, as described above. In particular, intra-prediction processing unit 46 may determine an intra-prediction mode to use to encode a current block. In some examples, intra-prediction processing unit 46 may encode a current block using various intra-prediction modes, e.g., during separate encoding passes, and intra-prediction processing unit 46 may select an appropriate intra-prediction mode to use from the tested modes. For example, intra-prediction processing unit 46 may calculate rate-distortion values using a rate-distortion analysis for the various tested intra-prediction modes, and may select the intra-prediction mode having the best rate-distortion characteristics among the tested modes. Rate-distortion analysis generally determines an amount of distortion (or error) between an encoded block and an original, unencoded block that was encoded to produce the encoded block, as well as a bit rate (that is, a number of bits) used to produce the encoded block. Intra-prediction processing unit 46 may calculate ratios from the distortions and rates for the various encoded blocks to determine which intra-prediction mode exhibits the best rate-distortion value for the block.

In any case, after selecting an intra-prediction mode for a block, intra-prediction processing unit 46 may provide information indicative of the selected intra-prediction mode for the block to entropy encoding unit 56. Entropy encoding unit 56 may encode the information indicating the selected intra-prediction mode. The encoding device 104 may include in the transmitted bitstream configuration data definitions of encoding contexts for various blocks as well as indications of a most probable intra-prediction mode, an intra-prediction mode index table, and a modified intra-prediction mode index table to use for each of the contexts. The bitstream configuration data may include a plurality of intra-prediction mode index tables and a plurality of modified intra-prediction mode index tables (also referred to as codeword mapping tables).

After prediction processing unit 41 generates the predictive block for the current video block via either inter-prediction or intra-prediction, the encoding device 104 forms a residual video block by subtracting the predictive block from the current video block. The residual video data in the residual block may be included in one or more TUs and applied to transform processing unit 52. Transform processing unit 52 transforms the residual video data into residual transform coefficients using a transform, such as a discrete cosine transform (DCT) or a conceptually similar transform. Transform processing unit 52 may convert the residual video data from a pixel domain to a transform domain, such as a frequency domain.

Transform processing unit 52 may send the resulting transform coefficients to quantization unit 54. Quantization unit 54 quantizes the transform coefficients to further reduce bit rate. The quantization process may reduce the bit depth associated with some or all of the coefficients. The degree of quantization may be modified by adjusting a quantization parameter. In some examples, quantization unit 54 may then perform a scan of the matrix including the quantized transform coefficients. Alternatively, entropy encoding unit 56 may perform the scan.

Following quantization, entropy encoding unit 56 entropy encodes the quantized transform coefficients. For example, entropy encoding unit 56 may perform context adaptive variable length coding (CAVLC), context adaptive binary arithmetic coding (CABAC), syntax-based context-adaptive binary arithmetic coding (SBAC), probability interval partitioning entropy (PIPE) coding or another entropy encoding technique. Following the entropy encoding by entropy encoding unit 56, the encoded bitstream may be transmitted to the decoding device 112, or archived for later transmission or retrieval by the decoding device 112. Entropy encoding unit 56 may also entropy encode the motion vectors and the other syntax elements for the current video slice being coded.

Inverse quantization unit 58 and inverse transform processing unit 60 apply inverse quantization and inverse transformation, respectively, to reconstruct the residual block in the pixel domain for later use as a reference block of a reference picture. Motion compensation unit 44 may calculate a reference block by adding the residual block to a predictive block of one of the reference pictures within a reference picture list. Motion compensation unit 44 may also apply one or more interpolation filters to the reconstructed residual block to calculate sub-integer pixel values for use in motion estimation. Summer 62 adds the reconstructed residual block to the motion compensated prediction block produced by motion compensation unit 44 to produce a reference block for storage in picture memory 64. The reference block may be used by motion estimation unit 42 and motion compensation unit 44 as a reference block to inter-predict a block in a subsequent video frame or picture.

In this manner, the encoding device 104 of FIG. 7 represents an example of a video encoder configured to perform the techniques described herein. For instance, the encoding device 104 may perform any of the techniques described herein, including the processes described herein. In some cases, some of the techniques of this disclosure may also be implemented by post processing device 57.

FIG. 8 is a block diagram illustrating an example decoding device 112. The decoding device 112 includes an entropy decoding unit 80, prediction processing unit 81, inverse quantization unit 86, inverse transform processing unit 88, summer 90, filter unit 91, and picture memory 92. Prediction processing unit 81 includes motion compensation unit 82 and intra prediction processing unit 84. The decoding device 112 may, in some examples, perform a decoding pass generally reciprocal to the encoding pass described with respect to the encoding device 104 from FIG. 7.

During the decoding process, the decoding device 112 receives an encoded video bitstream that represents video blocks of an encoded video slice and associated syntax elements sent by the encoding device 104. In some examples, the decoding device 112 may receive the encoded video bitstream from the encoding device 104. In some examples, the decoding device 112 may receive the encoded video bitstream from a network entity 79, such as a server, a media-aware network element (MANE), a video editor/splicer, or other such device configured to implement one or more of the techniques described above. Network entity 79 may or may not include the encoding device 104. Some of the techniques described in this disclosure may be implemented by network entity 79 prior to network entity 79 transmitting the encoded video bitstream to the decoding device 112. In some video decoding systems, network entity 79 and the decoding device 112 may be parts of separate devices, while in other instances, the functionality described with respect to network entity 79 may be performed by the same device that comprises the decoding device 112.

The entropy decoding unit 80 of the decoding device 112 entropy decodes the bitstream to generate quantized coefficients, motion vectors, and other syntax elements. Entropy decoding unit 80 forwards the motion vectors and other syntax elements to prediction processing unit 81. The decoding device 112 may receive the syntax elements at the video slice level and/or the video block level. Entropy decoding unit 80 may process and parse both fixed-length syntax elements and variable-length syntax elements in or more parameter sets, such as a VPS, SPS, and PPS.

When the video slice is coded as an intra-coded (I) slice, intra prediction processing unit 84 of prediction processing unit 81 may generate prediction data for a video block of the current video slice based on a signaled intra-prediction mode and data from previously decoded blocks of the current frame or picture. When the video frame is coded as an inter-coded (e.g., B, P or GPB) slice, motion compensation unit 82 of prediction processing unit 81 produces predictive blocks for a video block of the current video slice based on the motion vectors and other syntax elements received from entropy decoding unit 80. The predictive blocks may be produced from one of the reference pictures within a reference picture list. The decoding device 112 may construct the reference frame lists, List 0 and List 1, using default construction techniques based on reference pictures stored in picture memory 92.

Motion compensation unit 82 determines prediction information for a video block of the current video slice by parsing the motion vectors and other syntax elements, and uses the prediction information to produce the predictive blocks for the current video block being decoded. For example, motion compensation unit 82 may use one or more syntax elements in a parameter set to determine a prediction mode (e.g., intra- or inter-prediction) used to code the video blocks of the video slice, an inter-prediction slice type (e.g., B slice, P slice, or GPB slice), construction information for one or more reference picture lists for the slice, motion vectors for each inter-encoded video block of the slice, inter-prediction status for each inter-coded video block of the slice, and other information to decode the video blocks in the current video slice.

Motion compensation unit 82 may also perform interpolation based on interpolation filters. Motion compensation unit 82 may use interpolation filters as used by the encoding device 104 during encoding of the video blocks to calculate interpolated values for sub-integer pixels of reference blocks. In this case, motion compensation unit 82 may determine the interpolation filters used by the encoding device 104 from the received syntax elements, and may use the interpolation filters to produce predictive blocks.

Inverse quantization unit 86 inverse quantizes, or de-quantizes, the quantized transform coefficients provided in the bitstream and decoded by entropy decoding unit 80. The inverse quantization process may include use of a quantization parameter calculated by the encoding device 104 for each video block in the video slice to determine a degree of quantization and, likewise, a degree of inverse quantization that should be applied. Inverse transform processing unit 88 applies an inverse transform (e.g., an inverse DCT or other suitable inverse transform), an inverse integer transform, or a conceptually similar inverse transform process, to the transform coefficients in order to produce residual blocks in the pixel domain.

After motion compensation unit 82 generates the predictive block for the current video block based on the motion vectors and other syntax elements, the decoding device 112 forms a decoded video block by summing the residual blocks from inverse transform processing unit 88 with the corresponding predictive blocks generated by motion compensation unit 82. Summer 90 represents the component or components that perform this summation operation. If desired, loop filters (either in the coding loop or after the coding loop) may also be used to smooth pixel transitions, or to otherwise improve the video quality. Filter unit 91 is intended to represent one or more loop filters such as a deblocking filter, an adaptive loop filter (ALF), and a sample adaptive offset (SAO) filter. Although filter unit 91 is shown in FIG. 8 as being an in loop filter, in other configurations, filter unit 91 may be implemented as a post loop filter. The decoded video blocks in a given frame or picture are then stored in picture memory 92, which stores reference pictures used for subsequent motion compensation. Picture memory 92 also stores decoded video for later presentation on a display device, such as video destination device 122 shown in FIG. 1.

In this manner, the decoding device 112 of FIG. 8 represents an example of a video decoder configured to perform the techniques described herein. For instance, the decoding device 112 may perform any of the techniques described herein, including the processes described herein.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some examples, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the examples may be practiced without these specific details. For clarity of explanation, in some instances the present technology may be presented as including individual functional blocks including functional blocks comprising devices, device components, steps or routines in a method implemented in software, or combinations of hardware and software. Additional components may be used other than those shown in the figures and/or described herein. For example, circuits, systems, networks, processes, and other components may be shown as components in block diagram form in order not to obscure the examples and aspects in unnecessary detail. In other instances, well-known circuits, processes, algorithms, structures, and techniques may be shown without unnecessary detail in order to avoid obscuring the examples and aspects.

Individual examples and aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be implemented in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific examples thereof, but those skilled in the art will recognize that the application is not limited thereto. While illustrative examples and aspects of the application have been described in detail herein, it is to be understood that the inventive concepts may be otherwise variously implemented and employed, and that the appended claims are intended to be construed to include such variations, except as limited by the prior art. Various features and aspects of the above-described application may be used individually or jointly. Further, examples and aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate examples, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” means A, B, or A and B. In another example, claim language reciting “at least one of A, B, and C” means A, B, C, or A and B, or A and C, or B and C, or A and B and C. The language “at least one of” a set and/or “one or more” of a set does not limit the set to the items listed in the set. For example, claim language reciting “at least one of A and B” can mean A, B, or A and B, and can additionally include items not listed in the set of A and B.

The various illustrative logical blocks, modules, circuits, and algorithm steps described in connection with the examples and aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative examples of the disclosure include:
Aspect 1: An apparatus for processing video data, comprising: at least one memory; and at least one processor coupled to the at least one memory, the at least one processor configured to: obtain a frame of video data associated with a display of a computing device, wherein the frame of video data includes one or more layers; compare layer information associated with the one or more layers included in the frame of video data and layer information associated with one or more layers included in a previous frame of video data; generate, based on determining a frame geometry change associated with the frame of video data, an inter-predicted frame using the frame of video data; and determine an updated group of pictures (GOP) length based on the layer information associated with the one or more layers included in the frame of video data.
Aspect 2: The apparatus of Aspect 1, wherein the at least one processor is configured to determine the updated GOP length based on layer information associated with a primary layer included in the frame of video data.
Aspect 3: The apparatus of Aspect 2, wherein the primary layer included in the frame of video data is rendered using a z-order that is greater than a respective z-order associated with one or more additional layers included in the frame of video data.
Aspect 4: The apparatus of any of Aspects 1 to 3, wherein the layer information includes, for each respective layer included in the one or more layers, at least one of a layer name associated with each respective layer, a layer format associated with each respective layer, and one or more coordinates associated with each respective layer.
Aspect 5: The apparatus of any of Aspects 1 to 4, wherein the layer information includes at least one of a quantity of layers or a frame layer number.
Aspect 6: The apparatus of any of Aspects 1 to 5, wherein the at least one processor is configured to determine the frame geometry change associated with the frame of video data based on comparing the layer information associated with the one or more layers included in the frame of video data and the layer information associated with the one or more layers included in the previous frame of video data.
Aspect 7: The apparatus of Aspect 6, wherein, to determine the frame geometry change associated with the frame of video data, the at least one processor is configured to: determine that the layer information associated with the one or more layers included in the frame of video data have changed by greater than a threshold amount compared to the layer information associated with the one or more layers included in the previous frame of video data.
Aspect 8: The apparatus of any of Aspects 1 to 7, wherein the at least one processor is further configured to: determine that a frame geometry change is not associated with the frame of video data, based on the layer information associated with the one or more layers included in the frame of video data changing by less than a threshold amount compared to the layer information associated with the one or more layers included in the previous frame of video data.
Aspect 9: The apparatus of Aspect 8, wherein the at least one processor is further configured to: detect a display idle state associated with the frame of video data, based on the frame of video data and a pre-determined quantity of previous frames of video data not being associated with a frame geometry change; and apply a display idle GOP length, wherein the display idle GOP length is greater than the updated GOP length.
Aspect 10: The apparatus of any of Aspects 8 to 9, wherein the at least one processor is further configured to: encode the frame of video data as a predicted frame (P-frame) or a bidirectional frame (B-frame) based on the frame of video data not being associated with a frame geometry change.
Aspect 11: The apparatus of any of Aspects 1 to 10, wherein the frame of video data includes video display data displayed on a display of the computing device.
Aspect 12: The apparatus of any of Aspects 1 to 11, wherein the frame of video data is a frame of captured video display data associated with wireless display sharing from the computing device to a second computing device.
Aspect 13: The apparatus of Aspect 12, wherein the frame of video data and the previous frame of video data are sequential frames included in a plurality of frames of captured video display data.
Aspect 14: The apparatus of Aspect 13, wherein the at least one processor is further configured to: encode at least a portion of the plurality of frames of captured video display data using the inter-predicted frame.
Aspect 15: The apparatus of Aspect 14, wherein the at least one processor is further configured to: transmit encoded video data to a second device associated with a same wireless display sharing session as the computing device; wherein the encoded video data includes the inter-predicted frame and at least one of a uni-predicted frame or bi-predicted frame generated based on encoding at least the portion of the plurality of frames of captured video display data.
Aspect 16: A method for processing video data, comprising: obtaining a frame of video data associated with a display of a computing device, wherein the frame of video data includes one or more layers; comparing layer information associated with the one or more layers included in the frame of video data and layer information associated with one or more layers included in a previous frame of video data; generating, based on determining a frame geometry change associated with the frame of video data, an inter-predicted frame using the frame of video data; and determining an updated group of pictures (GOP) length based on the layer information associated with the one or more layers included in the frame of video data.
Aspect 17: The method of Aspect 16, wherein the updated GOP length is determined based on layer information associated with a primary layer included in the frame of video data.
Aspect 18: The method of Aspect 17, wherein the primary layer included in the frame of video data is rendered using a z-order that is greater than a respective z-order associated with one or more additional layers included in the frame of video data.
Aspect 19: The method of any of Aspects 16 to 18, wherein the layer information includes, for each respective layer included in the one or more layers, at least one of a layer name associated with each respective layer, a layer format associated with each respective layer, and one or more coordinates associated with each respective layer.
Aspect 20: The method of any of Aspects 16 to 19, wherein the layer information includes at least one of a quantity of layers or a frame layer number.
Aspect 21: The method of any of Aspects 16 to 20, wherein determining the frame geometry change associated with the frame of video data is based on comparing the layer information associated with the one or more layers included in the frame of video data and the layer information associated with the one or more layers included in the previous frame of video data.
Aspect 22: The method of Aspect 21, wherein determining the frame geometry change associated with the frame of video data comprises: determining that the layer information associated with the one or more layers included in the frame of video data have changed by greater than a threshold amount compared to the layer information associated with the one or more layers included in the previous frame of video data.
Aspect 23: The method of any of Aspects 16 to 22, further comprising: determining that a frame geometry change is not associated with the frame of video data, based on the layer information associated with the one or more layers included in the frame of video data changing by less than a threshold amount compared to the layer information associated with the one or more layers included in the previous frame of video data.
Aspect 24: The method of Aspect 23, further comprising: detecting a display idle state associated with the frame of video data, based on the frame of video data and a pre-determined quantity of previous frames of video data not being associated with a frame geometry change; and applying a display idle GOP length, wherein the display idle GOP length is greater than the updated GOP length.
Aspect 25: The method of any of Aspects 23 to 24, further comprising: encoding the frame of video data as a predicted frame (P-frame) or a bidirectional frame (B-frame) based on the frame of video data not being associated with a frame geometry change.
Aspect 26: The method of any of Aspects 16 to 25, wherein the frame of video data includes video display data displayed on a display of the computing device.
Aspect 27: The method of any of Aspects 16 to 26, wherein the frame of video data is a frame of captured video display data associated with wireless display sharing from the computing device to a second computing device.
Aspect 28: The method of Aspect 27, wherein the frame of video data and the previous frame of video data are sequential frames included in a plurality of frames of captured video display data.
Aspect 29: The method of Aspect 28, further comprising: encoding at least a portion of the plurality of frames of captured video display data using the inter-predicted frame.
Aspect 30: The method of Aspect 29, further comprising: transmitting encoded video data to a second device associated with a same wireless display sharing session as the computing device; wherein the encoded video data includes the inter-predicted frame and at least one of a uni-predicted frame or bi-predicted frame generated based on encoding at least the portion of the plurality of frames of captured video display data.
Aspect 31: An apparatus comprising: at least one memory; and at least one processor coupled to the at least one memory, wherein the at least one processor is configured to perform operations in accordance with any one of Aspects 1 to 30.
Aspect 32: An apparatus comprising means for performing operations in accordance with any one of Aspects 1 to 30.
Aspect 33: A non-transitory computer-readable medium having stored thereon instructions that, when executed by one or more processors, cause the one or more processors to perform operations according to any one of Aspects 1 to 30.

1. An apparatus for processing video data, comprising:
at least one memory; and
at least one processor coupled to the at least one memory, the at least one processor configured to:
obtain a frame of video data associated with a display of a computing device, wherein the frame of video data includes one or more layers;
compare layer information associated with the one or more layers included in the frame of video data and layer information associated with one or more layers included in a previous frame of video data;
generate, based on determining a frame geometry change associated with the frame of video data, an inter-predicted frame using the frame of video data; and
determine an updated group of pictures (GOP) length based on the layer information associated with the one or more layers included in the frame of video data.

2. The apparatus of claim 1, wherein the at least one processor is configured to determine the updated GOP length based on layer information associated with a primary layer included in the frame of video data.

3. (canceled)

4. The apparatus of claim 1, wherein the layer information includes, for each respective layer included in the one or more layers, at least one of a layer name associated with each respective layer, a layer format associated with each respective layer, and one or more coordinates associated with each respective layer.

5. The apparatus of claim 1, wherein the layer information includes at least one of a quantity of layers or a frame layer number.

6. The apparatus of claim 1, wherein the at least one processor is configured to determine the frame geometry change associated with the frame of video data based on comparing the layer information associated with the one or more layers included in the frame of video data and the layer information associated with the one or more layers included in the previous frame of video data.

7. (canceled)

8. The apparatus of claim 1, wherein the at least one processor is further configured to:
determine that a frame geometry change is not associated with the frame of video data, based on the layer information associated with the one or more layers included in the frame of video data changing by less than a threshold amount compared to the layer information associated with the one or more layers included in the previous frame of video data.

9. The apparatus of claim 8, wherein the at least one processor is further configured to:
detect a display idle state associated with the frame of video data, based on the frame of video data and a pre-determined quantity of previous frames of video data not being associated with a frame geometry change; and
apply a display idle GOP length, wherein the display idle GOP length is greater than the updated GOP length.

10. The apparatus of claim 8, wherein the at least one processor is further configured to:
encode the frame of video data as a predicted frame (P-frame) or a bidirectional frame (B-frame) based on the frame of video data not being associated with a frame geometry change.

11. (canceled)

12. The apparatus of claim 1, wherein the frame of video data is a frame of captured video display data associated with wireless display sharing from the computing device to a second computing device.

13. The apparatus of claim 12, wherein the frame of video data and the previous frame of video data are sequential frames included in a plurality of frames of captured video display data.

14. The apparatus of claim 13, wherein the at least one processor is further configured to:
encode at least a portion of the plurality of frames of captured video display data using the inter-predicted frame.

15. (canceled)

16. A method for processing video data, comprising:
obtaining a frame of video data associated with a display of a computing device, wherein the frame of video data includes one or more layers;
comparing layer information associated with the one or more layers included in the frame of video data and layer information associated with one or more layers included in a previous frame of video data;
generating, based on determining a frame geometry change associated with the frame of video data, an inter-predicted frame using the frame of video data; and
determining an updated group of pictures (GOP) length based on the layer information associated with the one or more layers included in the frame of video data.

17. The method of claim 16, wherein the updated GOP length is determined based on layer information associated with a primary layer included in the frame of video data.

18. (canceled)

19. The method of claim 16, wherein the layer information includes, for each respective layer included in the one or more layers, at least one of a layer name associated with each respective layer, a layer format associated with each respective layer, and one or more coordinates associated with each respective layer.

20. (canceled)

21. The method of claim 16, wherein determining the frame geometry change associated with the frame of video data is based on comparing the layer information associated with the one or more layers included in the frame of video data and the layer information associated with the one or more layers included in the previous frame of video data.

22. (canceled)

23. The method of claim 16, further comprising:
determining that a frame geometry change is not associated with the frame of video data, based on the layer information associated with the one or more layers included in the frame of video data changing by less than a threshold amount compared to the layer information associated with the one or more layers included in the previous frame of video data.

24. The method of claim 23, further comprising:
detecting a display idle state associated with the frame of video data, based on the frame of video data and a pre-determined quantity of previous frames of video data not being associated with a frame geometry change; and
applying a display idle GOP length, wherein the display idle GOP length is greater than the updated GOP length.

25. The method of claim 23, further comprising:
encoding the frame of video data as a predicted frame (P-frame) or a bidirectional frame (B-frame) based on the frame of video data not being associated with a frame geometry change.

26.-27. (canceled)

28. The method of claim 27, wherein the frame of video data and the previous frame of video data are sequential frames included in a plurality of frames of captured video display data.

29. The method of claim 28, further comprising:
encoding at least a portion of the plurality of frames of captured video display data using the inter-predicted frame.

30. (canceled)
